(19) United States
(12) Patent Application Publication
(10) Pub. No.: US 2025/0383265 A1
(43) Pub. Date: Dec. 18, 2025

(54) ACOUSTIC-DRIVEN SYSTEM IMPACT ANALYSIS AND REMEDIATION

(71) Applicant: Dell Products L.P., Round Rock, TX (US)

(72) Inventors: Ajay Maikhuri, Bangalore (IN); Dhilip Kumar, Bangalore (IN)

(73) Assignee: Dell Products L.P., Round Rock, TX (US)

(21) Appl. No.: 18/742,142

(22) Filed: Jun. 13, 2024

(51) Int. Cl. G01M 99/00; G01H 17/00; G06F 40/20; G10L 21/0208; G10L 21/0232

(52) U.S. Cl. CPC G01M 99/005; G01H 17/00; G06F 40/20; G10L 21/0232; G10L 2021/02082

(57) ABSTRACT

One or more detected sounds are received at a first system in a first location, the detected sounds generated in in a second system at a second location. Real-time noise removal is performed on the detected sounds to produce a set of noise removed sound information, which is analyzed to determine at least one classification of at least a portion of the set of noise removed sound information. The classification is correlated to a diagnosis of at least one potential issue in the first system. Based on the potential issue, one or more actions to take to respond to the potential issue, are generated automatically. Instructions, regarding the one or more actions to take to respond to the potential issue, are caused to be provided to one or more systems configured with power to perform the actions automatically and without human intervention.

### FIELD

Embodiments of the disclosure generally relate to systems and methods for analyzing and optimizing the performance of automated systems, such as computer systems, as well as predicting and/or detecting failures of components and/or subsystems of automated systems and equipment, based at least in part on acoustic information.

### BACKGROUND

Failure detection, prediction, and prevention is a generic and common problem across the information technology (IT) space. It is especially challenging when a component suddenly fails, seemingly without any prior detectable indicators of that the component is starting to go bad or about to fail. Despite major efforts, both in industry and academia, it can be challenging to find solutions that are reliable in helping to detect, predict, and/or prevent component, system, or other equipment failures, or to develop solutions that can help optimize performance.

### SUMMARY

The following presents a simplified summary in order to provide a basic understanding of one or more aspects of the embodiments described herein. This summary is not an extensive overview of all of the possible embodiments and is neither intended to identify key or critical elements of the embodiments, nor to delineate the scope thereof. Rather, the primary purpose of the summary is to present some concepts of the embodiments described herein in a simplified form as a prelude to the more detailed description that is presented later.

The world is becoming increasingly digitalized to save human time. Phone conversations are transformed into text, then images, then audio and video. Companies desire to provide rapid customer service. In addition, the consumer desires prompt assistance. As a result, customers share minimal digital information with companies to identify their problems, and companies also seek minimal digital information rather than communicating directly with customers. Traditionally, customers would call a support agent, discuss their issue, and spend time with the agent. Later, customers shifted to text-based chats with chatbots. If the problem is visible, or if a customer can check certain things and report back information (e.g., run a self-test and report back the results to a support agent), some types of remote diagnoses can take place. In other instances, if a problem is visible or can be conveyed with an image, additional images are captured (e.g., via a screen shot, or taking a photo of a defect or suspected problem) and a diagnosis request is made. In some instances, such as with high speed internet connections using a provider's equipment, such a connected modem or router, a remote provider system can attempt to send certain types of signals to customer equipment to help troubleshoot (e.g., reset signals). In other instances, a customer can go to a provider website to do certain types of troubleshooting on the customer's equipment, such as speed tests. In many instances, a customer will find a website for their product that provides guided instructions for self-troubleshooting. Whether independently or with assistance, remote diagnosis of problems is becoming more commonplace.

Despite the many types of troubleshooting available, there are some types of problems where a customer may not be able to identify a source of a problem, may not correctly attribute a specific parameter as contributing to a problem, or may not even be able to detect a problem, even with common arrangements for remote assistance in troubleshooting and diagnosis. There also may be instances where a customer simply is not capable of detecting a problem using their own human senses, whether because a problem is only apparent using special equipment that can detect things humans cannot or because other information (e.g., sounds) are masking the problem. In addition, even if a sound is detected or noticed, it can be time-consuming and inefficient to have to manually classify the sound and determine what caused it.

Current computer system diagnostic methods lack efficiency and immediacy, often requiring physical presence or complex software tools. There is a need for a novel approach that utilizes other approaches. The growing complexity of modern systems necessitates comprehensive approaches to analyze and address potential impacts. In this context, the integration of acoustic-driven methodologies offers a novel perspective. Certain embodiments herein are configured to use sound analysis, including in some embodiments machine-learning assisted sound analysis, to remotely diagnose hardware and software issues in computer systems, providing a faster and more accessible solution for problem identification and resolution.

In addition, many businesses commonly adopt a system log-based or error code-based approach for problem detection. Nevertheless, machines frequently generate unique noises that deviate from standard sounds. Variations in sound intensity often indicate malfunctions or machine shutdowns, potentially leading to operational issues and accidents that disrupt work and production efficiency. It would be advantageous to be able to analyze such variations to determine and classify them and, if possible, correlate the variations to a problem and provide a remediation, advantageously an automatic remediation.

In certain aspects, embodiments described herein propose various solutions to address at least some of these and other issues.

In certain embodiments herein, techniques are introduced to use an acoustic driven system impact analysis system to assess and mitigate system level effects and impacts, including by taking into account data such as audio data which may not be immediately recognized as important or problematic, to analyze it to recognize system level issues of concern that it may indicate, with machine learning model to further analyze this data and make useful predictions and recommendations about equipment that may be nearing failure or which may require other types of maintenance. In certain embodiments, a machine learning model is used to help improve this process and to help implement automated actions and/or make recommended manual to help minimize system town time. In certain embodiments, the machine learning model is further configured to take into account data beyond simply log data, such as audio data and recorded sounds. With use of the systems, methods, and devices discussed herein, a direct reduction in cost of service is expected due to a reduction of investigation and diagnosis hours.

In one embodiment, a computer-implemented method is provided. One or more detected sounds are received at a first system in a first location, the detected sounds being generated in in a second system at a second location. Real-time noise removal is performed on the detected sounds to produce a set of noise removed sound information. The set of noise removed sound information is analyzed to determine at least one classification of at least a portion of the set of noise removed sound information. The at least one classification is correlated to a diagnosis of at least one potential issue in the first system. Based on the at least one potential issue, one or more actions to take to respond to the at least one potential issue, are generated automatically. Instructions, regarding the one or more actions to take to respond to the at least one potential issue, are caused to be provided to one or more system configured to perform the actions automatically and without human intervention. In some embodiments, the first location is remote from the second location.

In certain embodiments, the computer-implemented method further includes converting the instructions into at least one of: natural language instructions provided to a human operator; control signals to enable a control system to automatically perform the one or more actions, where the control system is distinct from the first system and the second system; and control signals configured to cause at least one of the first system and the second system to automatically perform the one or more actions. In some embodiments, the real-time noise removal further comprises processing the detected sounds in a dual-signal transformation long short-term memory (DTLN) network.

In some embodiments, analyzing the set of noise removed sounds further comprises: converting the set of noise removed sound information into a corresponding set of spectrograms, each spectrogram in the corresponding set of spectrograms depicting an image of a sound pattern in the set of noise removed sound information; providing each spectrogram into a convolution neural network (CNN) to generate at least one feature map associated with each spectrogram, the feature map comprising an encoded representation of the spectrogram and configured to indicate at least one feature associated with the sound pattern; cross referencing the feature map to a database of known issues associated with one or more corresponding sound patterns; and determining at least one classification based on the feature map.

In some embodiments, the computer-implemented method further comprises providing a machine learning model that is configured to provides information used for performing at least one of: (a) determining the at least one classification of the at least a portion of the set of noise removed sound information; (b) correlating the at least one classification to the diagnosis of at least one potential issue in the first system; and (c) generating automatically, based on the at least one potential issue, one or more actions to take to respond to the at least one potential issue.

In some embodiments, analyzing the set of noise removed sounds further comprises performing audio data augmentation (ADA) on each spectrogram in the corresponding set of spectrograms before providing the spectrogram to the machine learning model, wherein the ADA is configured to improve a training data set used with the machine learning model. In some embodiments, at least one spectrogram in the set of spectrograms comprises a Mel spectrogram.

In certain embodiments, analyzing the set of noise removed sounds further comprises standardizing the set of noise removed sounds before converting the set of noise removed sounds into a corresponding set of spectrograms. In certain embodiments, the classification corresponds to textual information and wherein correlating the at least one classification to a diagnosis further comprises: analyzing the textual information via context analysis of a machine learning model having a knowledge repository; and determining a diagnosis based on an analysis of whether the textual information matches information stored in the knowledge repository.

In another aspect, a system is provided, comprising a processor; and a non-volatile memory in operable communication with the processor and storing computer program code that when executed on the processor causes the processor to execute a process operable to perform certain operations. The operations include receiving, at a first system in a first location, one or more detected sounds, the detected sounds being generated in in a second system at a second location; performing real-time noise removal on the detected sounds to produce a set of noise removed sound information; analyzing the set of noise removed sound information to determine at least one classification of at least a portion of the set of noise removed sound information; correlating the at least one classification to a diagnosis of at least one potential issue in the first system; generating automatically, based on the at least one potential issue, one or more actions to take to respond to the at least one potential issue; and causing instructions, regarding the one or more actions to take to respond to the at least one potential issue, to be provided to one or more systems configured with power to perform the actions automatically and without human intervention.

In some embodiments, the system further comprises computer program code that when executed on the processor causes the processor to perform an action comprising converting the instructions into at least one of: natural language instructions provided to a human operator; control signals to enable a control system to automatically perform the one or more actions, wherein the control system is distinct from the first system and the second system; and control signals configured to cause at least one of the first system and the second system to automatically perform the one or more actions. In some embodiments of the system, the real-time noise removal further comprises processing the detected sounds in a dual-signal transformation long short-term memory (DTLN) network.

In certain embodiments, the system further comprises computer program code that when executed on the processor causes the processor to perform actions comprising: converting the set of noise removed sound information into a corresponding set of spectrograms, each spectrogram in the corresponding set of spectrograms depicting an image of a sound pattern in the set of noise removed sound information; providing each spectrogram into a convolution neural network (CNN) to generate at least one feature map associated with each spectrogram, the feature map comprising an encoded representation of the spectrogram and configured to indicate at least one feature associated with the sound pattern; cross referencing the feature map to a database of known issues associated with one or more corresponding sound patterns; and determining at least one classification based on the feature map. In some embodiments of the system, at least one spectrogram in the set of spectrograms comprises a Mel spectrogram.

In some embodiments, the system further comprises computer program code that when executed on the processor causes the processor to perform an action comprising providing a machine learning model that is configured to provides information used for performing at least one of: (a) determining the at least one classification of the at least a portion of the set of noise removed sound information; (b) correlating the at least one classification to the diagnosis of at least one potential issue in the first system; and (c) generating automatically, based on the at least one potential issue, one or more actions to take to respond to the at least one potential issue.

In some embodiments, the system further comprises computer program code that when executed on the processor causes the processor to perform an action comprising at least one of: analyzing the set of noise removed sounds further comprises performing audio data augmentation (ADA) on each spectrogram in the corresponding set of spectrograms before providing the spectrogram to the machine learning model, wherein the ADA is configured to improve a training data set used with the machine learning model.

In certain embodiments, the classification corresponds to textual information and the system further comprises computer program code that when executed on the processor causes the processor to perform actions comprising: analyzing the textual information via context analysis of a machine learning model having a knowledge repository; and determining a diagnosis based on an analysis of whether the textual information matches information stored in the knowledge repository.

In another aspect, another computer-implemented method is provided. One or more detected sounds are received at a first system in a first location, the detected sounds being generated in in a second system at a second location. Real-time noise removal is performed on the detected sounds to produce a set of noise removed sound information. The set of noise removed sound information is analyzed, using a machine learning model, to determine at least one classification of at least a portion of the set of noise removed sound information. The at least one classification is correlated to a diagnosis of at least one potential issue in the first system. Based on the at least one potential issue, one or more actions to take to respond to the at least one potential issue are generated automatically. Instructions, regarding the one or more actions to take to respond to the at least one potential issue, are caused to be provided to one or more systems configured to perform the actions automatically and without human intervention.

In some embodiments, the computer-implemented method further comprises processing the detected sounds in a dual-signal transformation long short-term memory (DLTN) network. In some embodiments, the computer-implemented method further comprises converting the set of noise removed sound information into a corresponding set of spectrograms, each spectrogram in the corresponding set of spectrograms depicting an image of a sound pattern in the set of noise removed sound information; providing each spectrogram into a convolution neural network (CNN) to generate at least one feature map associated with each spectrogram, the feature map comprising an encoded representation of the spectrogram and configured to indicate at least one feature associated with the sound pattern; cross referencing the feature map to a database of known issues associated with one or more corresponding sound patterns; and determining at least one classification based on the feature map.

In some embodiments, the computer-implemented method further comprises performing audio data augmentation (ADA) on each spectrogram in the corresponding set of spectrograms before providing the spectrogram to the CNN, wherein the ADA is configured to improve a training data set used with the machine learning model.

Implementations of the described techniques may include hardware, a method or process, or computer software on a computer-accessible medium.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims included herein.

Details relating to these and other embodiments are described more fully herein.

### BRIEF DESCRIPTION OF THE DRAWINGS

The advantages and aspects of the described embodiments, as well as the embodiments themselves, will be more fully understood in conjunction with the following detailed description and accompanying drawings, in which:

FIG. 1A is an exemplary first flowchart illustrating, at a high level, steps of an acoustic system impact analysis and remediation methodology, in accordance with one embodiment;

FIG. 1B is a simplified exemplary architecture of an acoustic-driven system, in accordance with one embodiment;

FIG. 1C is an exemplary second flowchart of a method for acoustic-driven problem analysis and resolution, usable in the acoustic-driven system of FIG. 1B, in accordance with one embodiment;

FIG. 2 is an exemplary first flow diagram of a Dual-Signal Transformation Long Short-Term Memory Network (DTLN) model, in accordance with one embodiment;

FIG. 3A is an exemplary first graph, showing audio signal processing using a Short-time Fast Fourier Transform (STFT) arrangement, in accordance with one embodiment;

FIG. 3B is an exemplary third flowchart of a method of STFT, usable as part of the method of FIG. 1C and the first flow diagram of FIG. 2, in accordance with one embodiment;

FIG. 4 is an exemplary second graph, showing signal processing in a Fast Fourier Transform (FFT) environment, in accordance with one embodiment;

FIG. 5A is an exemplary second flow diagram of audio classification, usable as part of the method of FIG. 1C, in accordance with one embodiment;

FIG. 5B is an exemplary fourth flowchart of a method of audio classification, usable as part of the method of FIG. 1C, in accordance with one embodiment;

FIG. 6A is an exemplary third graph showing a sound signal in accordance with one embodiment;

FIG. 6B is an exemplary fourth graph showing a spectrogram of the sound signal of FIG. 6A, in accordance with one embodiment;

FIG. 7 is an exemplary block diagram of a recommendation engine, including an impact detection system, in accordance with one embodiment; and

FIG. 8 is a block diagram of an exemplary computer system usable with at least some of the systems, methods, examples, graphs, and outputs of FIGS. 1B-7, in accordance with one embodiment.

The drawings are not to scale, emphasis instead being on illustrating the principles and features of the disclosed embodiments. In addition, in the drawings, like reference numbers indicate like elements.

### DETAILED DESCRIPTION

Before describing details of the particular systems, devices, arrangements, frameworks, and/or methods, it should be observed that the concepts disclosed herein include but are not limited to a novel structural combination of components and circuits, and not necessarily to the particular detailed configurations thereof. Accordingly, the structure, methods, functions, control and arrangement of components and circuits have, for the most part, been illustrated in the drawings by readily understandable and simplified block representations and schematic diagrams, in order not to obscure the disclosure with structural details which will be readily apparent to those skilled in the art having the benefit of the description herein.

Illustrative embodiments will be described herein with reference to exemplary computer and information processing systems, in particular the environment of a computer system. It is to be appreciated, however, that embodiments are not restricted to use with the particular illustrative system and device configurations shown and are not restricted to storage array environments.

Unless specifically stated otherwise, those of skill in the art will appreciate that, throughout the present detailed description, discussions utilizing terms such as “opening”, “configuring,” “receiving,”, “detecting,” “retrieving,” “converting”, “providing,”, “storing,” “checking”, “uploading”, “sending,”, “determining”, “reading”, “loading”, “overriding”, “writing”, “creating”, “including”, “generating”, “associating”, and “arranging”, and the like, refer to the actions and processes of a computer system or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The disclosed embodiments are also well suited to the use of other computer systems such as, for example, optical and mechanical computers. Additionally, it should be understood that in the embodiments disclosed herein, one or more of the steps can be performed manually.

In addition, as used herein, terms such as “module,” “system,” “subsystem”, “engine,” “gateway,” “device,”, “machine”, “interface, and the like are intended to refer to a computer-implemented or computer-related in this application, the terms “component,” “module,” “system”, “interface”, “engine”, or the like are generally intended to refer to a computer-related entity or article of manufacture, either hardware, software, a combination of hardware and software, software, or software in execution. For example, a module includes but is not limited to, a processor, a process or program running on a processor, an object, an executable, a thread of execution, a computer program, and/or a computer. That is, a module can correspond to both a processor itself as well as a program or application running on a processor. As will be understood in the art, modules and the like can be distributed on one or more computers.

Further, references made herein to “certain embodiments,” “one embodiment,” “an exemplary embodiment,” and the like, are intended to convey that the embodiment described might be described as having certain features or structures, but not every embodiment will necessarily include those certain features or structures, etc. Moreover, these phrases are not necessarily referring to the same embodiment. Those of skill in the art will recognize that if a particular feature is described in connection with a first embodiment, it is within the knowledge of those of skill in the art to include the particular feature in a second embodiment, even if that inclusion is not specifically described herein.

Additionally, the words “example” and/or “exemplary” are used herein to mean serving as an example, instance, or illustration. No embodiment described herein as “exemplary” should be construed or interpreted to be preferential over other embodiments. Rather, using the term “exemplary” is an attempt to present concepts in a concrete fashion. In addition, the articles “a” and “an” as used in this application and the appended claims should be construed to mean “one or more” unless specified otherwise or clear from context to be directed to a singular form.

Before describing in detail, the particular improved systems, devices, and methods, it should be observed that the concepts disclosed herein include but are not limited to a novel structural combination of software, components, and/or circuits, and not necessarily to the particular detailed configurations thereof. Accordingly, the structure, methods, functions, control and arrangement of components and circuits have, for the most part, been illustrated in the drawings by readily understandable and simplified block representations and schematic diagrams, in order not to obscure the disclosure with structural details which will be readily apparent to those skilled in the art having the benefit of the description herein.

The following detailed description is provided, in at least some examples, using the specific context of a computer network operable coupled to a plurality of devices, including but not limited to internet of Things (IOT) connected devices, including modifications and/or additions that can be made to such a system to achieve the novel and non-obvious improvements described herein, but the disclosures and embodiments herein are not so limited. Those of skill in the art will appreciate that the embodiments herein may have advantages in many contexts other than a networked computer. Thus, in the embodiment herein, specific reference to specific activities and environments is meant to be primarily for example or illustration. Moreover, those of skill in the art will appreciate that the disclosures herein are not, of course, limited to only the types of examples given herein, but are readily adaptable to many different types of arrangements that involve monitoring, predicting, and mitigating for the failure of components, systems, devices, etc., where data is collected that associated with the operation and/or performance of the component, system, and/or device.

Some computer-controlled systems include maintenance software running (e.g., in the background, on demand, etc.) to perform condition monitoring, which monitors one or more parameters in a system (e.g., temperature, response time, the value of particular voltage, vibration, etc.), wherein a normal baseline range is established for the parameter, so that deviation from that normal range may provide information about the health of one or more system components. Condition monitoring often involves continuous or periodic checks made while a system is operating or running, but some types of condition monitoring can be performed on demand or as part of specific troubleshooting.

One type of condition monitoring is acoustics condition monitoring, which can include analysis of a noise spectrum associated with a given component or system. Acoustic condition monitoring can be advantageous as part of troubleshooting, maintenance, and/or predictive maintenance (i.e., anticipating future failures, faults, etc.). Acoustic condition monitoring uses various techniques, processing, and types of equipment to detect sound waves, including sound waves at frequencies that are inaudible to humans and/or challenging for humans to hear. A normally operating system may have a first, stable noise spectrum, and different types of conditions and/or problems can change the first stable noise spectrum to an unstable or different noise spectrum. Such spectrum changes are not always discernable by a human operator, but sometimes can be detectable when specific equipment is used for detection or when specific processing is performed on the noise information. Being able to isolate and identify specific parts of a noise spectrum can be a helpful feature in acoustic condition monitoring.

The advantages of acoustic condition monitoring include early detection of potential faults, real-time knowledge of asset health, and the ability to maximize asset lifecycles. Acoustic condition monitoring advantageously can be implemented so that is non-invasive and cost-effective and can be applied to a wide range of machines and systems. It can be used in various industries and domains, such as manufacturing, energy, transportation, and healthcare. The use of sensors and other sound-detecting tools (e.g., handheld ultrasound tools paired with software) can be crucial parts of a predictive maintenance program that is based on acoustic condition monitoring. That is, acoustic/sound data collection can be done manually and/or automatically.

In environments such as computer systems, storage arrays, backup systems, servers, etc., unexpected downtime arising from equipment failures can be very costly to customers. Some manufacturers have tried to leverage predictive maintenance techniques to try and identify possible device and equipment issues before these issues lead to disruption. In systems where there are many sensors constantly churning data about components, using all possible sources of data, including acoustic and/or audio data, can seem straightforward to combine with predictive maintenance. However, using acoustic information, such as acoustic condition information, can be more challenging with some types of machinery, components, computer systems, devices, and arrangements, etc., because of various factors, including interference from other sources of noise, the large volume of potential data to analyze, the issue of properly classifying data, and the remote nature of some types of problem solving. Hardware and/or software issues can be difficult to diagnose, because of the volume of data and also because of other system factors and sounds that can mask the development of hardware issues. It can be difficult to analyze acoustic and/or audio data. In addition, with computer systems, being able to proactively take automated action to minimize system downtime can be more challenging than in other types of environments. Further, an end user may not even be aware that certain sounds are indicative of an issue or may not even be able to discern or hear some types of system sounds.

The growing complexity of modern systems necessitates comprehensive approaches to analyze and address potential impacts of hardware and/or software failures. In this context, the integration of acoustic-driven methodologies offers a novel perspective, especially when combined with machine learning, as discussed further herein.

At least some of the embodiments herein introduce the concept of Acoustic-Driven System Impact Analysis and Remediation, a framework that harnesses the power of sound-related data to assess and mitigate system-level effects. By leveraging advanced audio sensing technologies and signal processing techniques, including either or both of unsupervised and supervised machine learning, this approach enables a nuanced understanding of the intricate interplay between sound phenomena and system performance. Through real-time monitoring and analysis, coupled with targeted remediation strategies, as discussed further herein, in certain embodiments herein, organizations can enhance their ability to detect and counteract adverse impacts, ensuring optimized system functionality and reliability.

At least some embodiments herein explore the theoretical foundations, practical implementation, and benefits of the Acoustic-Driven System Impact Analysis and Remediation framework across various domains, illustrating its potential to revolutionize the way entities can perceive and manage system dynamics.

Modern computer systems are intricate ecosystems with numerous interdependent components. Ensuring their optimal functionality and diagnosing problems promptly is crucial. Traditional diagnostic methods often require physical presence or sophisticated software tools. Acoustic-Driven System Impact Analysis and Remediation offers a fresh perspective, utilizing the sounds emitted by a computer system to provide insights into its health and potential issues.

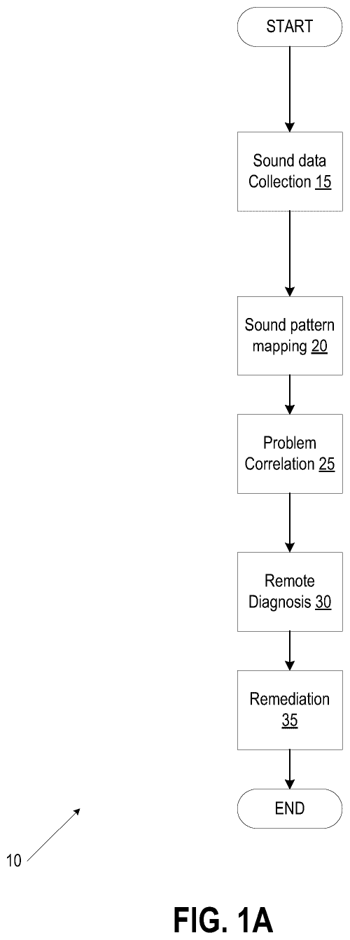

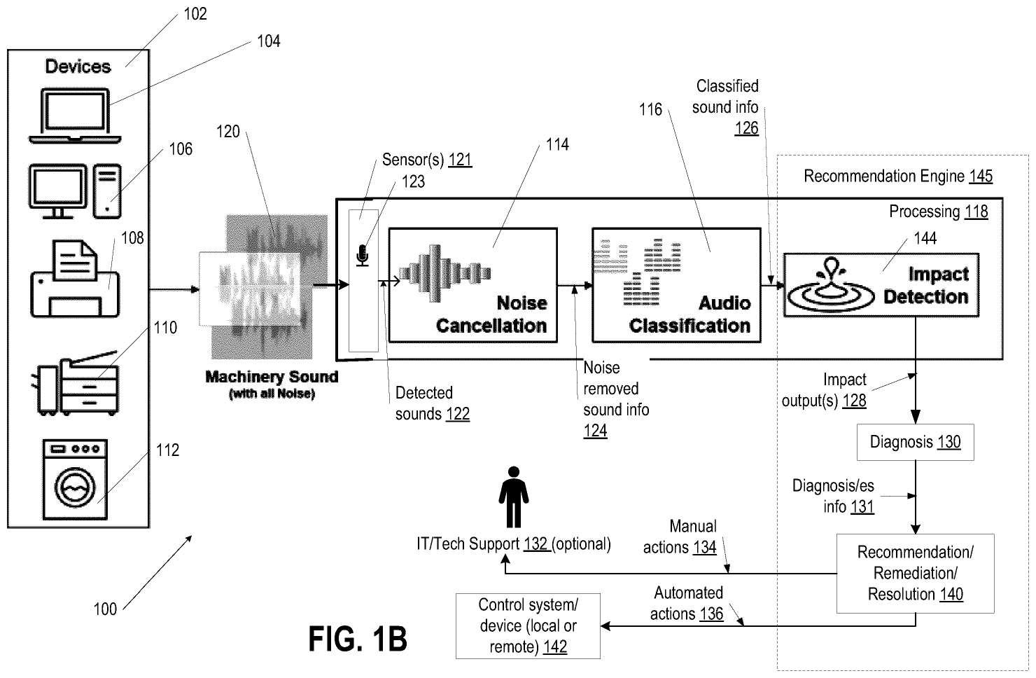

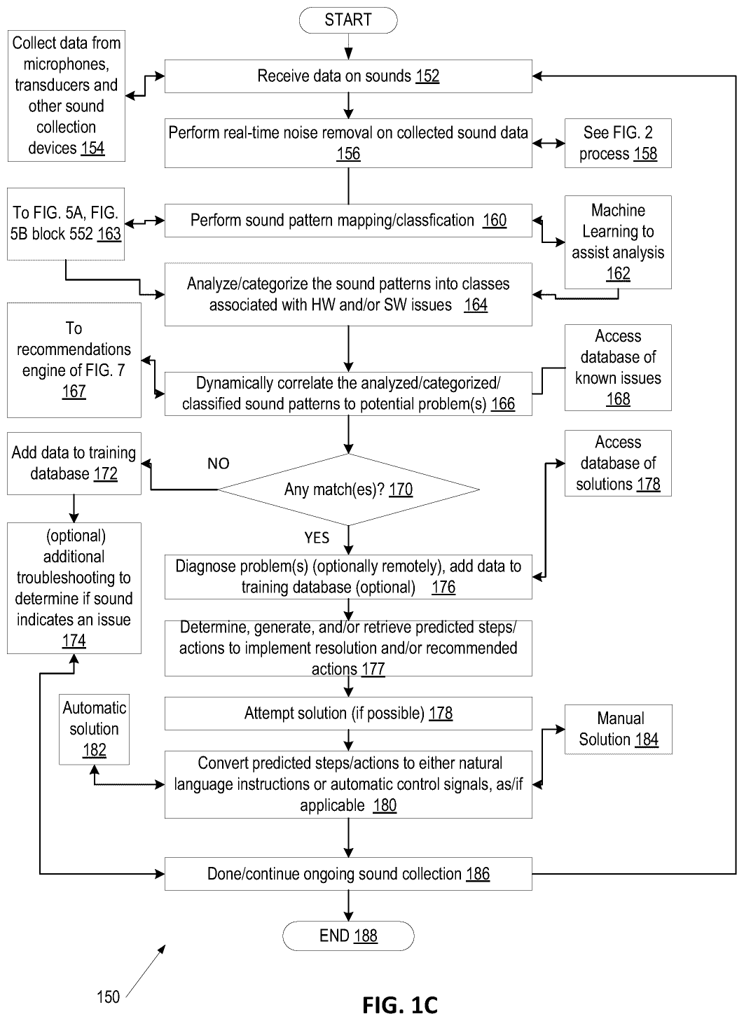

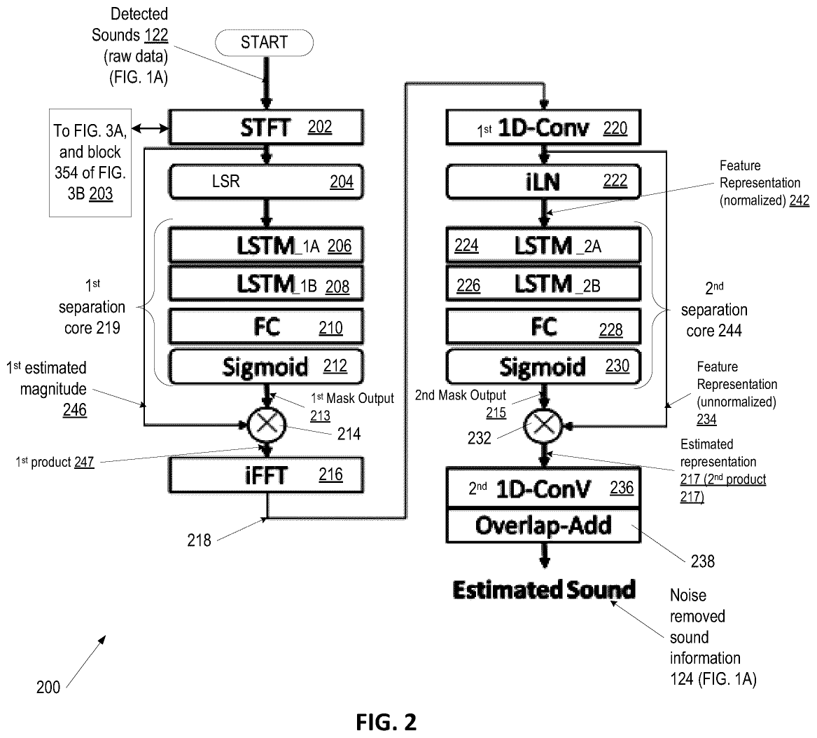

In at least some embodiments herein, the Acoustic-Driven System Impact Analysis and Remediation methodology involves the following steps, as shown in FIG. 1A, which is an exemplary first flowchart 10 1illustrating, at a high level, steps of an acoustic system impact analysis and remediation methodology, in accordance with one embodiment. These steps include Sound Data Collection (block 15): Microphones are strategically placed within the system to capture auditory signals during normal operation. These sounds encompass various vibrations, frequencies, and patterns generated by the system's components such as fans, hard drives, and processors.
Sound Pattern Mapping (block 20): Recorded sound data is analyzed to identify distinct sound patterns. Machine learning techniques, such as clustering algorithms, can be applied to categorize these patterns into different classes, each corresponding to specific hardware or software issues.
Problem Correlation (block 25): By cross-referencing the identified sound patterns with a comprehensive database of known issues, a correlation can be established between specific sound patterns and the potential problems they signify. This correlation forms the basis of the remote diagnosis process.
Remote Diagnosis (block 30) and Remediation (block 35): The system transmits recorded sounds, embedded within telemetry data, to a centralized engine driven by machine learning, e.g., from a first location (where a system may be located) to a second location (which may be a remote location, i.e., a location that is remote, e.g., geographically, logically, network-wise, from the first location). This engine continuously scrutinizes the sounds, cross-referencing them with a repository of established problems. This dynamic correlation empowers precise remote diagnostics and preemptively offers actionable suggestions for issue resolution.

At least some embodiments discussed herein of an Acoustic-Driven Computer System Impact Analysis and Remediation approach offer several benefits and applications. For example, at least some embodiments enable remote diagnosis, such that diagnosing issues no longer requires the physical presence of a technician, resulting in decreased response times and operational expenses. At least some embodiments herein provide a methodology that improves efficiency by accelerating the diagnosis process by eliminating trial and error from many troubleshooting approaches. In addition, at least some embodiments herein provide early detection, including pre-emptive identification of potential issues through sound pattern changes can prevent major system failures. Further, at least some embodiments herein provide a better customer experience, enhancing customer experience by proactively diagnosing issues without the need for customer complaints, and promptly delivering actionable solutions.

Noise removal implementations often are provided to try to capture certain types of audio information, such as the sound of a human voice, in a better manner. It is less common to try and eliminate the sound of a human voice from audio data, so as to focus on particular noises or parts of a noise spectrum. At least some embodiments herein seek to identify different types of sounds, such as wired noise associated with a machine, by eliminating all form of known noises and ambient noises from the sample signal, even including, where applicable, the human voice as well.

FIG. 1B is a simplified exemplary architecture diagram of an acoustic-driven system 100, in accordance with one embodiment, and FIG. 1C is an exemplary second flowchart 150 of a method for acoustic-driven problem analysis usable in the acoustic-driven system of FIG. 1B, in accordance with one embodiment. The acoustic-driven system 100 of FIG. 1B includes a first set 102, comprising a set of network-connected devices that emit machinery sound(s) 120, which sound is detected by one or more sensors 121 (e.g., microphone 123 or other transducers and/or other devices capable of collecting sound) that are in operable communication with a processing module 118. The sound 120, in certain embodiments, is part of a set of telemetry data that is wirelessly transmitted to the processing module 118 via a computer network (not shown). In certain embodiments, the processing module 118 is in operable communication with one or more sensors 121 that collect sound 120 and/or other telemetry data, a noise cancellation module 114, an audio classification module 116 and a recommendation engine 145. The recommendation engine 145, in certain embodiments, further includes an impact detection module 144, a diagnosis module 130, and a remediation/resolution module 140. The recommendation engine 145, in certain embodiments, is in operable communication with one or more control system/devices 142 and, optionally, one or more personnel such as IT/Tech support 132.

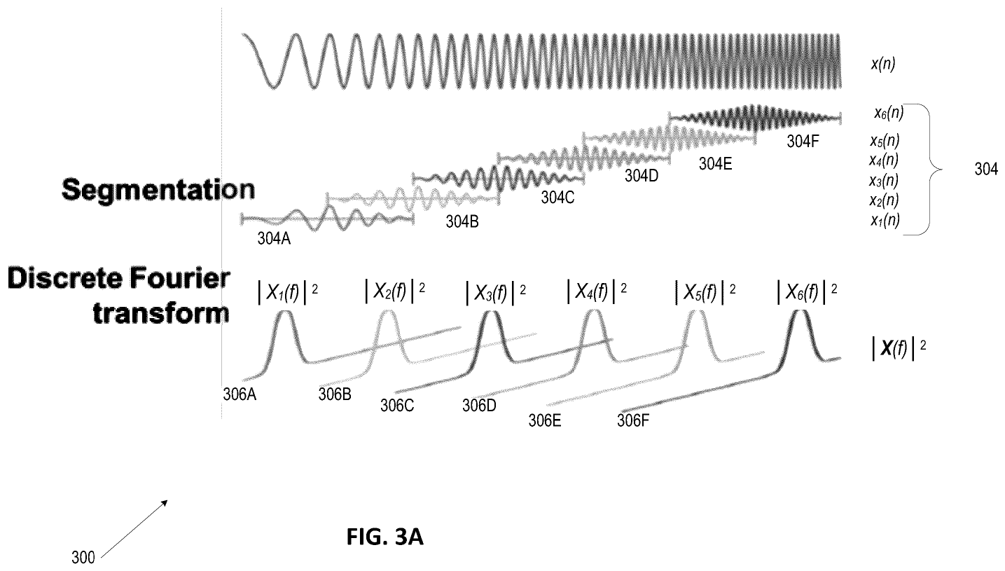

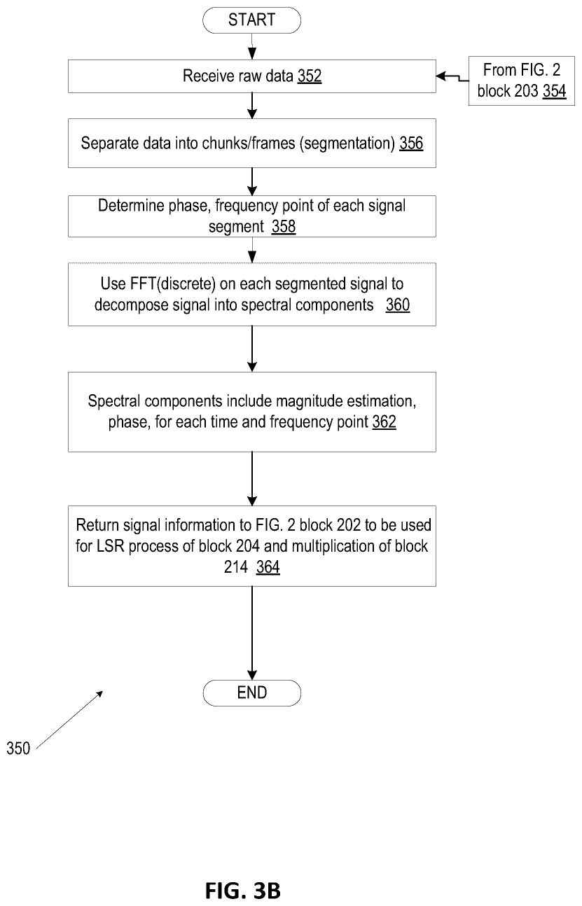

Referring again to FIGS. 1B and 1C, when sound data is received (block 152, block 154) at the processing module 118, the noise cancellation module 114 processes the received detected sounds 122, as noted above and further discussed below in FIG. 2, to produce noise removed sound information 124 (block 156, block 158) and provides this noise removed sound information 124 to the audio classification module 116, which is configured to perform sound pattern mapping and classification (block 160). The audio classification module 116 also further processes the noise removed sound information 124 to produce classified sound information 126 (block 162, block 163). The recommendation engine 145 receives the classified sound information 126 at its impact detection module 144, to analyze and categorize the sound patterns into classes that are associated with hardware and/or software issues (block 164). The recommendation engine 145 also attempts to dynamically (e.g., on the fly) correlate the analyzed/categorized and/or classified sound patterns to potential and/or known problems (blocks, 166-170). If matches to problems are found (answer at block 170 is YES) the data is processed to produce one or more impact output(s) 128, which are provided to a diagnosis module 130, to which produces one or more diagnoses 131, advantageously remote diagnoses, with data added to a training database (block 176, block 178). The recommendation/remediation/resolution module 140, determines, based on the one or more diagnoses, if any action(s) is/are possible to mitigate, prevent, repair, and/or remedy the issue(s) giving rise to the one or more diagnoses, via determining, generating and/or retrieving predicted steps/actions to implement resolution and/or recommended actions (block 177) and further determines if the action(s) (if any found) will include a solution, if possible (block 178). If a solution is attempted, then the predicted steps/actions are converted to either natural language instructions or automatic control signals, as applicable (block 180) to provide either or both of a manual solution (block 184) or an automatic solution (block 182). That is, in blocks 177-178, in certain embodiments, the recommendation engine 145 causes instructions regarding the one or more actions to be provided to one or more entities with power to perform the actions. The entities with power to perform the actions can be human (e.g., IT/Tech support 132) or other systems/devices, which can perform the actions in response to a control signal, advantageously automatically and without human intervention (e.g., control system/device 142, which may be a local device/system or a remote device/system). In some embodiments, the control system/device 142 may be disposed at the same location as where the noise was generated. In some embodiments, the control system/device 142 may be disposed at a location that is separate and distinct from either or both of the location where the sound was generated and the location performing the noise reduction, classification, etc. It also will be appreciated that the actions taking place in the method FIG. 1C can each be accomplished in a different location and/or in a different system. These actions are explained further herein, and further details about all of this processing, generated signals, and recommended actions, are described further below in connection with FIGS. 1C-7.

Referring still to FIG. 1C, if the answer at block 170 is NO, then the classified sound data does not match any problems, which can mean one or more other things, depending on the sound and its context. For example, it may mean that the classified sound data is not, in fact, problematic, or that the sound data corresponds to a problem not previously seen (and thus should be added to the training database (block 172), or that the sound data requires some manual troubleshooting (block 174), etc.

Referring to FIG. 1B, the first set 102 of devices from which sound(s) is/are collected can include virtually any kind of network-connected devices or IoT type of device, including but not limited to devices such as a laptop computer 104, a desktop computer 106, a printer 108, a copier 110, and even home appliances 112, such as a washing machine. These devices emit one or more detected sounds 122 that collectively produce the machinery sound(s) 120 (which includes all noise) that is picked up by one or more sensors 121 (e.g., as part of telemetry data) and are provided as detected sounds 122 to the noise cancellation module 114.

Referring to FIGS. 1B and 1C, in block 152, the data that is received in this block can include machinery and other device/equipment and machinery sound(s) 120 that the sensors 121 detect, e.g., from microphone 123, or other transducers and/or sound collection devices (block 152) as detected sounds 122. The sound data may be collected at a first location and transmitted over a network (e.g., a wireless network) to be received at a second location that is remote from the first location. The sensor(s) 121 provide information on the detected sounds 122 to the noise cancellation module 114, which is configured to perform real-time noise removal on the collected sound data (block 156) via the process of FIG. 2 (block 158). As will be appreciated, the sensors 121 can be disposed locally (including by being attached to and/or embedded in a device) and can be configured to transmit data remotely, including over networks such as a cloud network (not shown in FIG. 1B). Although communications networks are not expressly illustrated in FIG. 1B, implementations of system such as acoustic-driven system 100 of FIG. 1B that include networks will be readily apparent to those of skill in the art.

In certain embodiments, the noise cancellation module 114 of FIG. 1B is configured to identify specific types of noise from the machines and other devices in the first set 102 of devices, e.g., wired noise, noise from faulty and/or marginal components, system noises indicative of faults, alarms, etc., by eliminating all or substantially all (as much as possible) forms of known noises and ambient noises that are not pertinent to analysis of a potential problem, even noise from the human voice, if necessary. In certain embodiments, the noise cancellation module 114 incorporates a dual-signal transformation LSTM network (DTLN) to help eliminate intrusive acoustic reverberation from the detected sounds 122. Using a stacked network approach, the DTLN as applied herein is combines a short-time Fourier transformation and a learned feature representation, which enables robust information processing in the time-frequency and time domains, which implementation also incorporates phase information. Although some aspects of this technique have been applied to improve processing of speech, it has not yet been applied to improve processing of machine and/or wired noise by eliminating other noise pollution.

As will be understood, if audio (e.g., detected sounds 122) is recorded in an open/factory area or while a machine/device was operating, the audio may contain acoustic pollution. Consequently, acoustic pollution or noise elimination, e.g. via processes run in the noise cancellation module 114 (as discussed further herein), is essential, in certain embodiments, prior to accurately classifying the sound that must be identified. After noise removal, the audio classification module 115 (which performs sound classification) is configured to classify the noise removed sound information 124, using deep learning that converts sound to spectrograms, inputs them into a convolution neural network (CNN) plus Linear Classifier model, and generates predictions about the sound's class. This arrangement, discussed further herein, entails learning to classify sounds and predict their classification. The acoustic-driven system 100 of FIG. 1B is configured to link the expected classification of a sound (classified sound information 126) and with remediation (e.g., via remediation/resolution module 140) and offers the reasons of the resolution store based on the classification that it has predicted.

Reference is now made briefly to FIG. 2, which is a first exemplary flow diagram 200 of a Dual-Signal Transformation Long Short-Term Memory Network (DTLN) model, in accordance with one embodiment. In certain embodiments, a dual-signal transformation LSTM network (DTLN) is utilized for dynamic noise cancellation of the received detected sounds 122, in real time.

Generally, a DTLN includes involves 2 separation centers (also known as stages). Initially, received sound is processed with a Short Time Fourier Transform (STFT) to get signal magnitude, and the resultant signal is passed to a neural network to get a vector result by which the signal magnitude is multiplied. Then, an Inverse Fast Fourier Transform (iFFT) is performed on the product to convert the product back to time domain, and that product (still corresponding to the received sound signal) is then sent to the second separation center/stage. At the output of the second separation center, the result corresponds to an estimated sound that, advantageously, corresponds to a completely noise-remove signal. This is all explained in FIG. 2. Note also that examples of detected sounds are discussed further herein in connection with FIG. 3A.

As shown in FIG. 2, the DTLN model in this embodiment consists of two separation centers, the first of which (block 202) uses an STFT signal transformation and the second of which (block 204) uses a learned signal representation (LSR). This arrangement is designed to enable the second core to further enhance the signal with phase information while the first core produces a strong magnitude estimation. Long Short-Term Memory (LSTM) is the type of neural network that employs these gates, in certain embodiments. The implementation of FIG. 2 shows two separation cores (i.e., first separation core 219 and second separation core 244), each having a respective pair LSTM layers (i.e., LSTM_1 206 and LSTM_2 208 of the first separation core 219, and LSTM_2A 224 and LSTM_2B of the second separation core 244) which are followed, in each separation core, by a respective fully connected (FC) layer (i.e., first fully connected layer 210 in the first separation core 219 and second fully connected layer 228 in the second separation core 244) and then by a respective sigmoid activation (i.e., first sigmoid activation 212 in the first separation core and second sigmoid activation 230 in the second separation core 244). This arrangement provides, out of each respective separation core, a respective mask output (i.e., first mask output 213 in the first separation core 219 and second mask output 215 in the second separation core 244). This achieves the stacked dual-signal transformation LSTM network design.

In the first separation core 219 the mask predicted by the FC layer 210 and first sigmoid activation 212 is multiplied (block 214 at output of first separation core 219) by the first magnitude 246 of the mixture. In the first separation core 219, the first magnitude 246 of the mixture corresponds to the output of STFT 202, i.e., first magnitude 246. In the second separation core 244, the second magnitude that is multiplied in block 232 corresponds to the unnormalized feature representation 234, which is the output of the first one-dimensional convolution (1D-Conv) layer 220; this unnormalized feature representation 234 is multiplied in block 232 by the second mask output 215 out of the second sigmoid activation 230.

After the first multiplication block 214 of the first mask 213 output and first magnitude 246, the resulting first product 247 is translated back to the time domain, via the inverse FFT (iFFT) (block 216) producing a time domain output 218, which process uses the phase of the input mixture (i.e., the phase associated with first magnitude) 246 without recreating the waveform in the first separation core 219.

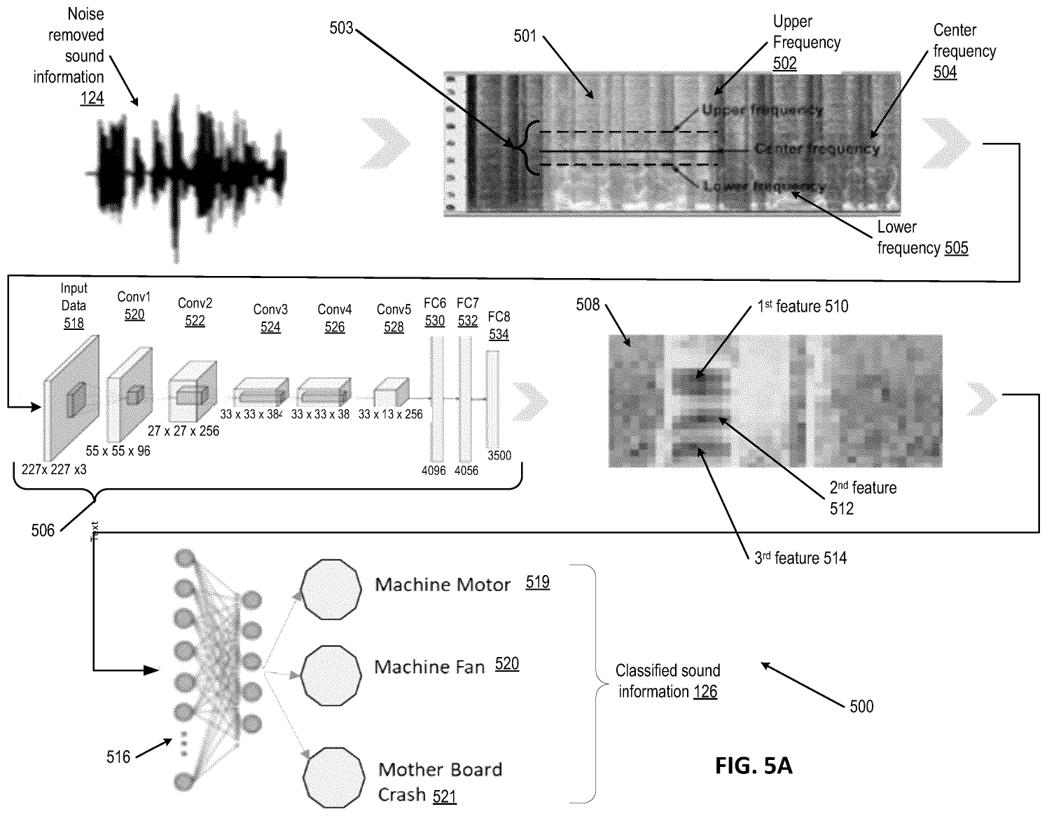

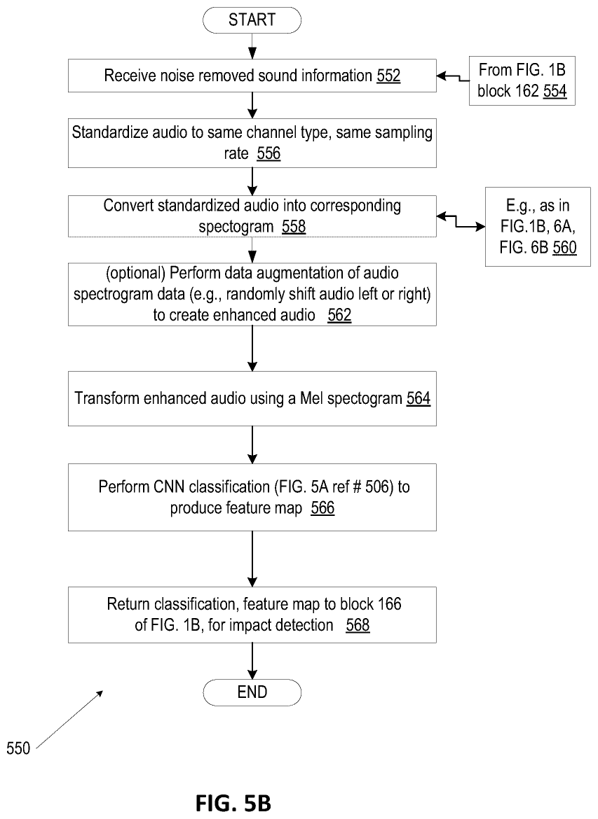

Referring still to FIG. 2, the time domain output 218 is provided to a first one-dimensional convolution (1D-Conv) layer 220, which processes the frames from the first network to generate the unnormalized feature representation 234. A normalizing layer (e.g., instant layer normalization (iLN) block 222) processes the unnormalized feature representation 234 into a normalized feature representation 242, before the normalized feature representation 242 is provided to the second separation core 244. The second predicted mask (2^{nd} mask output 215) is the predicted mask of the second separation core 244 and is multiplied by the unnormalized feature representation 234, at block 232. The output of the second multiplication at block 232, referred to as estimated representation 217 (i.e., second product 217) is then transmitted to a second 1D-Conv layer 236, which translates the estimated representation 217 back to the time domain. Finally, an overlap and addition technique (block 238) is used to rebuild the signal and produce estimated sound 240, which is effectively the noise removed sound information 124 that is input into the audio classification module 116 (FIG. 1B). This estimated sound 240/noise removed sound information 124 is shown as the audio data at the start of the input in FIG. 5A, discussed further herein.

Reference is now made briefly to FIG. 3A, which is a first exemplary graph 300 of audio signal processing using a Short-time Fast Fourier Transform (STFT) arrangement, in accordance with one embodiment and to FIG. 3B, which is a second exemplary flowchart 350 of a method of STFT, usable as part of the method of FIG. 1C and the flow diagram of FIG. 2, in accordance with one embodiment.

Referring to FIG. 1C, FIG. 2, FIG. 3A and FIG. 3B, the top signal in FIG. 3A (labeled as x(n)) shows raw audio data that is received as detected sounds 122, which data is received into the noise cancellation module 114 as raw data (block 352 of FIG. 3B, which is from block 203 of FIG. 2 (block 354)). As FIG. 3A illustrates, the exemplary raw sound signal x(n) is a sinusoidal type of signal, although this is not limiting. This signal represents the machinery sound(s) 120 (FIG. 1B) that the sensors 121 pick up as detected sounds 122 (FIG. 1B). As those of skill in the art will appreciate, the machine sound may be recorded at various frequencies, which can change over time. As a result, the Short-time Fast Fourier Transform (STFT) 202 (FIG. 2) is a layer of assistance that determines the sinusoidal frequency and phase content of tiny sections of a signal as they change over time. The method of FIG. 3B shows in greater detail how the STFT 202 of FIG. 2 is accomplished.

Referring still to FIGS. 1B-3B, the raw data is separated into chunks or frames via a segmentation process (block 356) which advantageously segments a larger temporal (time based) signal into segments of substantially equal length, e.g., the segments 304A, 304B, 304C, 304D, 304E, and 304F of FIG. 3A. This is done because STFTs are calculated by segmenting a larger temporal signal into equal-length segments and applying the Fourier transform to each segment separately. The layer computes and returns the STFT's magnitude and phase (block 358) in the final dimension.

Referring to FIG. 3B, in block 360, a discrete Fast Fourier Transform (FFT) is used on each segment 304A-304F (FIG. 3A) to decompose each respective segment signal into a set of one or more respective spectral components, which components also thus provides frequency information. This results in spectral components for each segment, including a magnitude estimation and phase, for each time and frequency point (block 362). The segmented chunks/frames, in certain embodiments, overlap to help decrease artifacts at the border, as shown in the segments 304A-304F of FIG. 3A. Discrete-time STFT (block 360) is used to convert the data (segmented data of block 356) into the signals shown, in FIG. 3A as the corresponding discrete Fourier transforms 306A-306F, of each segment 304A-304F. That is, the FFT decomposes the signal into its spectral components and thus provides frequency information (block 360), where the spectral components include a magnitude estimation and a phase for each time and frequency point (block 362) and this signal information is returned to FIG. 2, block 202 to be used in conjunction with the LSR process of block 204 and to be used as the first magnitude 246 (estimated) that input into the multiplication of block 214. The complex outcome of each chunk is added to a matrix that contains magnitude and phase for each time and frequency point.

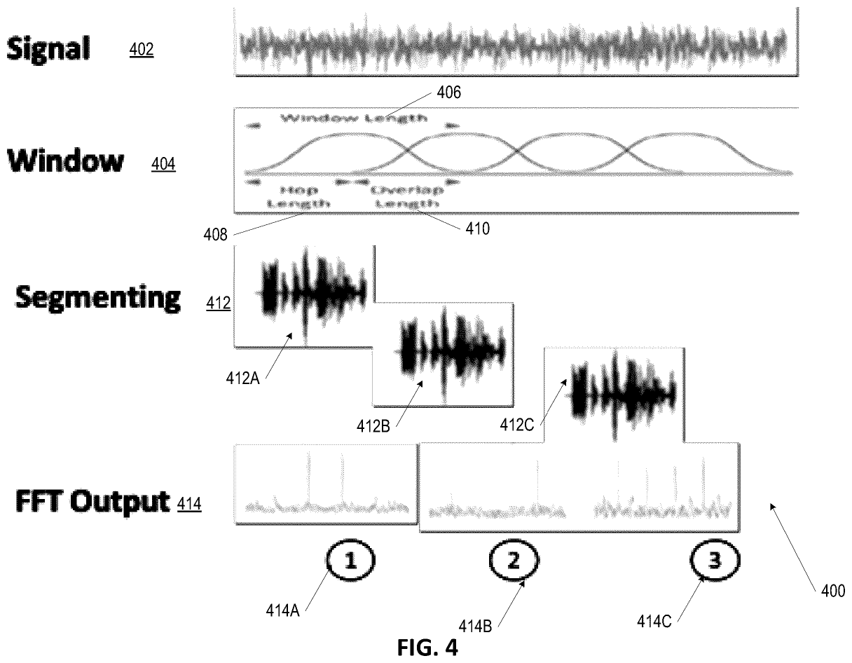

Reference is now made briefly to FIG. 4, which is a second exemplary graph 400, showing signal processing in an FFT environment, in accordance with one embodiment. The sound signal 402 is segmented into chunks (as discussed previously) by choosing a set of windows 404 to define the segment size, with each window having a window length 406 that is made up of a hop length 408 and an overlap length 410. As noted previously, having the chunk or frame size have overlap helps to minimize artifacts at the border between segments. FIG. 4 also depicts an illustrative example of the segmenting of a sound signal 402, with an illustrative example of a first segment 412A, a second segment 412B, and a third segment 412C. The FFT outputs 414 depict the spectra of each signal, e.g., first spectrum 414A for first segment 412A, second spectrum 414B for second segment 412B, and third spectrum 414C for third segment 412C.

In block 364 of FIG. 3A, the information on these spectral components of FIG. 4 (“signal information”) is returned to the flow diagram method of FIG. 2, at block 202, to be used as input to the learned signal representation (LSR) process of block 204 and as the first magnitude 246 (estimated) that is part of the multiplication of block 214 (block 364).

Referring again to block 202 of FIG. 2, the magnitude estimation (which was computed in block 362 of FIG. 3B, as noted above) is returned to the STFT block 202, which is part of the first “separation center” of first separation core 219. The second separation center (LSR block 204) of the first separation core 219 helps to further enhance the sound signal with phase information. In FIG. 2, the first LSTM layer of the first separation core 219 has two blocks: LSTM_1A 206 and LSTM_1B 2. The first LSTM (Long Short-Term Memory) Layer is constructed with long-term memory. Using an LSTM layer, long-term relationships between time phases in time series and sequence data are learned. The LSTM layer has two states: the concealed state (also known as the output state) and the cell state. At time step t, the output of the LSTM layer is stored in the hidden state. The Spectrum of Frequencies each pulse contains is shown in the FFT Outputs 414 of FIG. 4.

As is known, a Direct Fourier Transform (DFT) signal is produced by the distribution of value sequences to various frequency components. Such direct translation using the Fourier transform is computationally inefficient. As a result, in at least some embodiments herein, the Fast Fourier (FFT) transform is utilized because it computes the DFT matrix rapidly by factoring it as the product of sparse factors. This transformation is a translation from configuration space to frequency space, and it is essential for studying problem transformations for more efficient computing and signal power spectrum exploration.

To construct and compile the DTLN Model using the method of FIG. 2, the DLTN model uses time domain bundles having a size expressed in terms of batchsize, length in samples). The batchsize defines the number of samples that will be processed, and the length defines the chunk or segment size of each sample. The model DLTN model then generates enhanced segments of the same dimensions (e.g., same length). In certain embodiment, the model is trained using an example optimizer, such as the so-called “Adam” (adaptive moment estimation) optimizer. As is known, optimizers are algorithms or functions that can be configured to adjust attributes of the neural network, such as weights and learning rate, to help in reducing the overall loss and improving accuracy. Adam is a type of adaptive learning rate algorithm that is configured to help reduce/improve the speed of training deep neural networks. Advantageously, the Adam optimizer is able to reach convergence efficiently and rapidly because Adam can customize the learning rate of one or more parameters based on a gradient history of that parameter. However, use of Adam is not limiting and other neural network optimizers, e.g., various deep-learning optimizers, such as Gradient Descent, Stochastic Gradient Descent, Stochastic Gradient descent with momentum, Mini-Batch Gradient Descent, Adagrad, RMSProp, and/or AdaDelta, can be configured to be usable in various embodiments, as will be appreciated.

In certain embodiments, as the training process's optimizer, the Adam optimizer with a gradient norm clipping of 3 is used (though this is not limiting). There are two separation elements included in the model of FIG. 2. To learn a transformation, the first separation element employs an STFT signal transformation (e.g., STFT of block 202), while the second separation uses a 1D-Conv layer (e.g., the first 1D-Conv layer 220). By training this DTLN Mode, the noise data is being eliminated from the detected sounds 122 and the expected audio signal is being received in the audio classification module 116 as noise removed sound information 124.

Referring again to the acoustic-driven system 100 of FIG. 1B and the exemplary second flow chart 150 of FIG. 1C, it can be seen that then next step after performing the real-time noise removal of collected sound data of block 156 (i.e., in noise cancellation module 114), involves performing sound pattern mapping and classification (block 160), via audio classification module 116. Sound Classification (also known as audio classification) is one of the most widely used applications in Audio Deep Learning and involves learning to classify sounds and to predict the category of that sound. An example of sound/audio classification includes actions such as classifying audio to identify the genre of the music or classifying short utterances.

At a high level, audio classification, in certain embodiments herein, involves the following actions, which are each explained further herein and which are also part of the method of FIG. 5B:
Convert the audio data (advantageously noise removed) into its corresponding spectrogram (blocks 552-558)
Optionally, augment the spectrogram data (block 562)
Provide a Convolution Neural Network (CNN) to process the audio data (e.g., in Mel spectrogram form) and to extract feature maps that are an encoded representation of the spectrogram image (blocks 564-566), where the feature map can be configured to indicate at least one feature associated with a sound pattern in the audio data;
Cross reference the feature maps and other identified sound patterns to a database of known issues associated or correlated to the feature maps and/or sound patterns (block 568).

FIG. 5A is an exemplary second flow diagram 500 of audio classification, usable as part of the method of FIG. 1C, in accordance with one embodiment. FIG. 5B is an exemplary fourth flowchart 550 of a method of audio classification, usable as part of the method of FIG. 1C, in accordance with one embodiment. FIGS. 5A and 5B together help to implement blocks 164-163 of FIG. 1C and, in certain embodiments, provide the machine learning to assist analysis (block 162 of FIG. 1C).

Referring to FIGS. 1B, 1C, 5A and 5B, the noise removed sound information 124 is received (block 552), at the start of processing in the audio classification module 116, in the exemplary fourth flowchart 550. To help with accuracy of audio classification, it is helpful first to standardize the audio (block 556) such as to the same channel type (stereo or mono) and/or to same sampling rate. As is understood, in certain environments, a majority of the sound files recorded by audio recording devices are stereo (i.e., have two audio channels); however, some sound files may be recorded and stored in mono (one audio channel). For accuracy in audio classification, it is advantageous if most or all audio objects have the same dimensions. Thus, in certain embodiments, mono files are converted to stereo by duplicating the first channel to the second channel, and stereo files are converted to mono by either adding the two channels together and putting in one channel or picking just one of the two channels. Other appropriate means are usable.

To standardize sampling rate, techniques such as time shifting are usable. For example, consider an implementation where some sound files are encoded at 48000 Hz, while others are encoded at 44100 Hz. In this example, this means that 1 second of audio for some sound files will have an array size of 48000, while for others sound files, the array size will be 44100 for 1 second of audio. By standardizing and converting all audio to the same sampling rate, the dimensions of all arrays will be identical. This can be done via known techniques in the art, such as upsampling to the higher of two standard sample rates, using commercially available standardization software, etc.

In block 558 of FIG. 5B, the standardized audio is converted to a corresponding spectrogram. As is understood, a spectrogram provides a snapshot of an audio wave in image form, where, advantageously, the image (especially if it a Mel spectrogram, as discussed further herein) is suitable as an input to a convolution neural network (CNN) type of image handling architecture. For example, a spectrogram may depict an image of a sound pattern, such as a sound pattern found in the noise removed sound 124. Spectrograms are generated from sound signals by breaking up the sound signal into segments, applying a Fourier transform to each segment (to determine the constituent frequencies present in that segment) and then combining the transforms from all the segments into a single plot, which shows, in graph showing frequency (y-axis) vs time (x-axis), the amplitude of each frequency present in the signal. In some types of plots, a Spectrogram uses different colors and/or different levels of brightness to designate the amplitude of each frequency. For example, in some spectrograms, the brighter the color, the higher the energy of the signal.

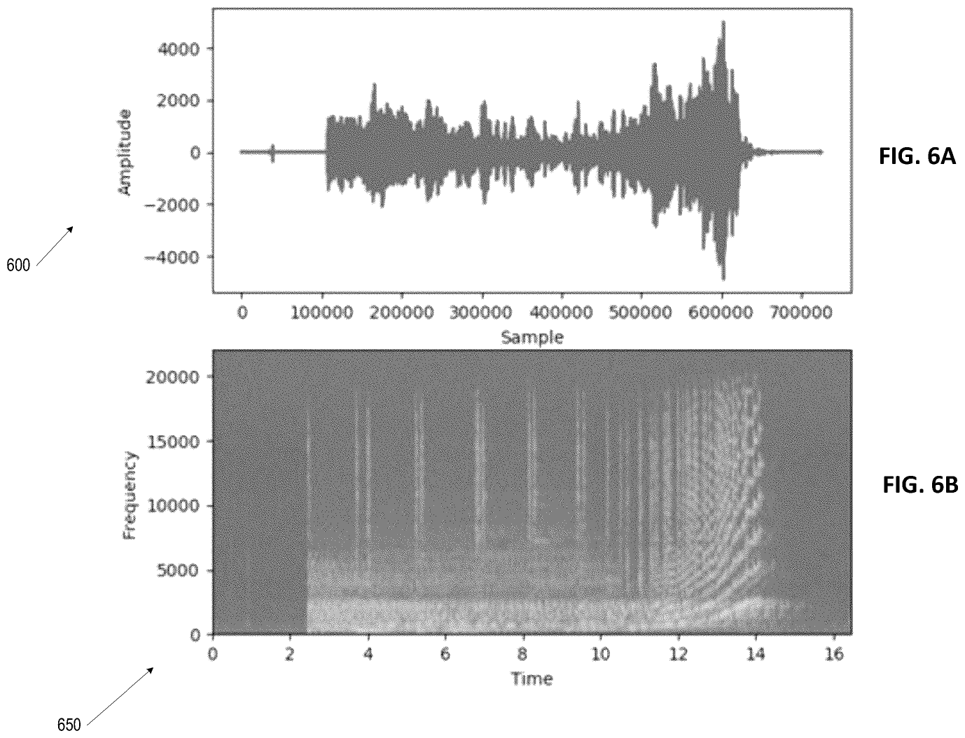

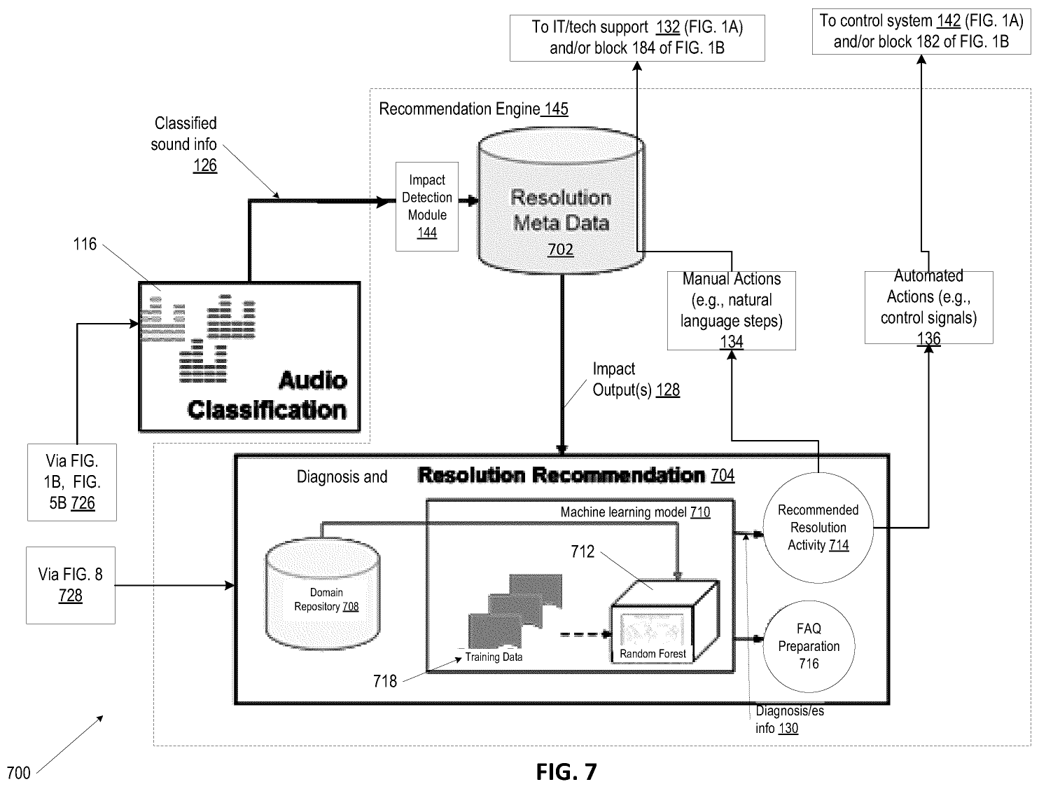

An example of a sound file and its corresponding spectrogram is shown in FIG. 6A, which is an exemplary third graph 600 showing a sound signal in accordance with one embodiment, and in FIG. 6B, which is an exemplary fourth graph showing a spectrogram of the sound signal of FIG. 6A, in accordance with one embodiment. The exemplary third graph 600 of FIG. 6A shows a signal in the time domain, i.e., Amplitude vs Time. The exemplary third graph 600 is able to convey a sense of how loud or quiet a given sound clip is at any point in time; however, the exemplary third graph 600 gives very little information about which frequencies are present in the sounds that are shown. In contrast, the exemplary fourth graph 650 of FIG. 6B, which shows the spectrogram of the signal in FIG. 6A, displays the same signal of FIG. 6A but in the frequency domain.

Referring again to FIG. 5B, after converting the standardized audio into its corresponding spectrogram (block 558), the method optionally performs audio data augmentation ADA) on the audio spectrogram (block 562), such as by randomly shifting the audio left or right. Data augmentation is a technique that can artificially increase the size of a training set by creating modified copies of a dataset using existing data. For example, in some arrangements, data augmentation involves applying several transformations or modifications to existing data samples, generating new samples that retain the same label or class as the original data. With ADA, this can be done in various ways, such as by includes making minor changes to the dataset (e.g., applying controlled transformations and modifications to existing audio samples, randomly shifting audio left or right, amplitude scaling, time and/or frequency masking, changing speed, changing pitch, etc.), or by using deep learning to generate new data points. A goal of many types of ADA is to create new data instances that retain the essential characteristics of the original audio, but with variations or perturbations, which can be helpful for training. For example, in the context of improving noise reduction, to train a model to implement noise reduction, some ADA can be configured to add random noise to the training audio signal.

Thus, in accordance with some embodiments herein, performing ADA on audio information, such as audio spectrograms, has advantages, especially for creating and training neural networks and machine learning types of systems. For example, ADA (and other types of data augmentation) can improve the quality and size of a training data set, can help improve the accuracy of a model, can help prevent a model from overfitting, etc. ADA also can be cost effective in creating additional data points at a low cost. ADA, in some embodiments herein, is performed on the noise removed sound information 124. ADA, in some embodiments, is performed on the unprocessed audio signals (i.e., the detected sounds 122, before noise removal).

Referring again to FIG. 5B, after the optional data augmentation to enhance the audio file (block 562), the (optionally enhanced) audio file is transformed using a Mel Spectrogram (block 564). As is known, a Mel Spectrogram differs from a regular spectrogram because the Mel spectrogram uses a so-called “Mel” scale, instead of frequency, on its y-axis. The Mel scale is based on a non-linear transformation of the frequency scale based on the pitch's perception and uses a decibel (dB) scale, instead of amplitude, to indicate colors. Thus, in accordance with some embodiments herein, each spectrogram (whether a regular spectrogram of a Mel spectrogram) of a signal plots its frequency spectrum over time and is like a “photograph” of the signal. The Mel spectrogram, like other spectrograms, plots time on the x-axis and frequency on the y-axis. The image that results comes together as if the spectrum was taken again and again, at different instances in time, and then joined all together into a single plot. The Mel spectrogram, advantageously, uses different colors to indicate the amplitude or strength of each frequency, where the brighter the color the higher the energy of the signal. Each vertical ‘slice’ of the spectrogram is essentially the spectrum of the signal at that instant in time and shows how the signal strength is distributed in every frequency found in the signal at that instant.

The Mel spectrograms, and their associated Mel scales are more commonly used with deep learning models, instead of regular spectrograms, because Mel spectrograms result in a much more detailed image representation of the audio signal, while also capturing the essential characteristics of the audio signal, enabling use of well-researched image classification techniques, including CNN. Mel spectrograms are frequently the optimal method for feeding audio data into deep learning models and, in certain embodiments herein, are preferred rather than a regular/simple spectrogram. In addition, the Mel scale closely mimics human perception, to help offer a good representation of the frequencies that humans typically hear. Referring briefly to FIG. 5A, the Mel spectrogram image 501 that is shown provides an illustrative example of a Mel spectrogram that was based on the noise removed sound information 124. As the Mel spectrogram image 501 illustrates, for a given set of sounds 503 that are received in an example system, the sounds have an upper frequency 502 a center frequency 504 and a lower frequency 505. Each frequency could, for example, represent a different audio feature and/or noise source, as will be appreciated.

Referring again to FIGS. 5A and 5B, after converting the audio into a Mel spectrogram image 501 (block 564), the Mel spectrogram image 501 is used as an input to a convolution neural network (CNN) 506, which is used to perform CNN classification to produce a feature map (block 566). CNN is widely described in the art, including in commonly assigned U. S. Patent Publication No. 20240054430, entitled, “Intuitive Al-Powered Personal Effectiveness In Connected Workplace,” published on Feb. 15, 2024, which is hereby incorporated by reference. In certain embodiments, the audio classification module 115 (FIG. 1B) uses CNN 506 classification (FIG. 5A) which, in one embodiment, consists of four convolutional blocks or layers (i.e., Conv1 520, Conv2 522, Conv3 524, Conv4 526, as shown in FIG. 5A) that generate feature maps. Each convolution layer uses filters that perform convolution operations as it is scanning the input/(i.e., input data 518, namely the Mel spectrogram image 501) with respect to its dimensions. Hyperparameters of a typical convolution layer include the filter size F and stride S, where each resulting output O is a feature map, but this is not limiting. Each convolutional layer applies the same (usually small) filter repeatedly at different positions in the layer below it.

For example, referring to the CNN 506 of FIG. 5A, each respective CNN layer (i.e., Conv1 520, Conv2 522, Conv3 524, Conv4 526) applies its filters to step up the image depth (i.e., number of channels). As FIG. 5A shows, in each convolution block/layer, the image width and height are reduced as the kernels and strides are applied. This can be seen, for example, with the first block Conv1 510 having image dimensions of 55×55×96, then second block Conv2 522 having image dimensions of 27×27×256, and so on.

Optional pooling layers (not shown in FIG. 5A) can be used in some embodiments to help to reducing the spatial dimensions of the input data 518, in terms of width and height, while retaining the most important information. Finally, after passing through the four CNN layers (i.e., Conv1 520, Conv2 522, Conv3 524, Conv4 526) the data is then transformed into the required format for input into the linear classifier layer (comprising fully connected (FC) layers FC6 530, FC7 532 FC8 534), which ultimately produces predictions for a predetermined number of classifications (e.g., an exemplary 10 classifications). The CNN process passes data through the three fully connected (FC) layers (FC6 530, FC7 532, FC8 534), to then output a feature map 508.

The fully connected (FC) layers (FC6 530, FC7 532 FC8 534) help to flatten the output, with each successive FC layer in FIG. 5A configured so that each neuron or node from the previous layer is connected to each neuron of the current layer (e.g., as shown in the FC connections 516). Referring again to FIG. 5A and FIG. 5B, the CNN 506 produces the feature map 508 used for classification. It should be understood that the feature map 508, with its designated example features (e.g., first feature 510, second feature 512, third feature 514) is exemplary and not limiting. In this example, the first feature 510 could, for example, correspond to a first sound from a first device, the second feature 512 could correspond to a second sound from a second device, and so on.

As is understood in the art, at least some feature maps generated via CNN, when applied to processing of audio, are configured to depict certain audio patterns and features (e.g., rhythm, pitch, frequency content, etc.) that are in a given audio signal. These audio patterns and features are learned via the convolution layers (and, optionally, the pooling layers). As the CNN 506 goes through each convolution and/or pooling layer, the learned features get combined, progressively, forming form higher-level features that correspond to different sound sources or audio events. The FC layers 530, 532, 534 learn complex, non-linear mappings between each layer, as shown in FC connections 516. Effectively, the convolution layers 520, 522, 524, 526, 528 help to break up the Mel spectrogram image that constitutes is the input data 518 into common features, and the FC layers 530, 532, 534 help to piece those common features together into objects or maps of features that correspond to entities that the CNN is to attempt to recognize or classify (block 568). For example, in FIG. 5A, the final classification outputs of the audio classification flow diagram 500 (exemplary second flow diagram 500) and audio classification method in the exemplary fourth flowchart 550, are the three audio classifications, which correspond to the classified sound information 126 (see also FIG. 1B) that are automatically detected in the noise removed sound information 124. In the example of FIG. 5A, one automatically detected feature is classified as machine motor 519. Another automatically detected features is classified as machine fan 520. And a further automatically detected feature is classified as mother board crash 521. As will be discussed further, based on these classifications, the classified sound information 126, along with the feature map 508, are returned (block 568 of FIG. 5B) to block 164 (FIG. 1C) and provided to an impact detection module 144 (FIG. 1B) to help to analyze and categorize the identified sound patterns and other classified sound information 126 into classes that may be associated with known or unknown hardware and/or software issues (block 164 of FIG. 1C), such as possible hardware or software issues associated with the motor, fan, motherboard, etc. For example, in one embodiment, a set of noise removed sounds is analyzed to determine at least one classification of at least a portion of the set of noise removed sounds.

Referring again to FIG. 1C, after the detected sounds 122 are classified (block 164), e.g., with an appropriate label (e.g., the labels such as “mother board crash 522” of FIG. 5A), the processing of FIG. 1C moves on to attempt to dynamically correlate the analyzed/categorized and classified sound patterns to at least one potential issue in the system where the was sound was recorded, where the at least one potential issue can correspond to one or more potential problems (block 166) in the system. In connection with this, the processing of block 166 makes use of a recommendation engine 145 to help determine if the detected and classified sound information 126 corresponds to a problem requiring action. FIG. 7 is an exemplary block diagram 700 of the recommendation engine 145, including an impact detection module 144, in accordance with one embodiment.

The recommendation engine 145 (which is shown in both FIG. 1B and FIG. 7, in varying levels of detail in each) includes an impact detection module 144, a database of resolution metadata 702, and a diagnosis and resolution recommendations module 704, and is configured to output one or both of automated actions 136 and manual actions 134. The diagnosis and resolution recommendations module 704 includes a domain/knowledge repository 708 and a machine learning model 710 and generates recommended resolution activity 714 and a frequently asked questions preparation information 716. The machine learning model 710 includes training data 718 that is fed into a random forest algorithm 712, along with information from the domain/knowledge repository 708. This is explained further herein.

Referring to FIGS. 1B, 1C, and 7, after the classified sound information 126 is generated by the audio classification module 115 (blocks 160-164 of FIG. 1C), information associated with the classification label is read from the resolution metadata 701 that is in operable communication with the impact detection module 144, where the information that is read is configured to help to start a process of dynamically correlating the analyzed, categorized and classified sound information and patterns to one or more potential problem(s) (block 166 of FIG. 1C). In certain embodiments, recommendation engine 145 also will use the analyzed, categorized, and classified sound information and patterns for training (blocks 176, 172), as will be understood.

In certain embodiments, based on the classified sound information 126, the impact detection module 144 performs a search of the resolution metadata 702 to determine if the classification of the sound is associated with or matches any potential problems for which there is data that a historical solution may exist (blocks 166-170 of FIG. 1C). If the answer at block 170 is YES, then the recommendation engine 145 communicates the corresponding resolution metadata 702 to the diagnosis and resolution recommendations module 704. Thus, the recommendation engine 145 is responsible for determining if the answer at block 170 (FIG. 1C) is “YES and, if the answer is YES, the recommendation engine 145 helps to recommend the steps needs to be taken to resolve a particular issue based on the historical step taken that resulted in a successful resolution. This information is determined, in some embodiments, based at least in part on one or more of the resolution metadata 702, the training data 718, and the information in the domain/knowledge repository 708, where the determination also is assisted, in certain embodiments, by machine learning model 710.

If the answer at block 170 is NO (no matches or recommended actions), then the data is added to the training data 718 of the recommendation engine 145 and, optionally, additional troubleshooting is done to determine whether the sound presents an issue requiring resolution (block 174). In some embodiments, this can require manual or off-line troubleshooting, and processing continues with ongoing sound collection (block 186).

If the answer at block 170 is YES, then the recommendation engine 145 can take action to assist based on historical steps taken that resulted in a successful resolution. In certain embodiments, the recommendation engine 145 has two critical functions: identifying/recommending the resolution activity and generating the resolution steps, where, in certain embodiments, the resolution steps includes either or both of an automated control signal provided to hardware or software modules/systems (to help resolve a given issue) and a manual recommended action, e.g., in the form of a natural language instruction so that human user, such as IT/Tech support 132, can take manual action(s) to resolve their issues. The diagnosis and resolution recommendation module 704 is configured to help identify the steps that need to be documented or learned so that either or both of the automated actions 136 and manual actions 134 can be generated.

For example, if there is manual action 134 (e.g., natural language steps to be taken by IT/Tech support 132), then the type of action is derived from a context analysis engine's intent and text analysis and is further based on information in a domain/knowledge repository 708, including context and information. As is understood, the context analysis engine, in certain embodiments, inherently is part of the machine learning model 710. For example, when (audio) image classification information, such as classified sound information 126, is received relating to a given topic, the recommendation engine 145, in certain embodiments, performs a search on the text/textual information that may be included as part of the classified sound information 126, to attempt to find the works that have been used and the context of the classification, including the participants, any past content (if applicable) and/or information along with intent and steps received from the context analysis engine.

As will be understood, context and/or domain can be important in analyzing sound information, because some sounds may be acceptable or non-problematic in certain contexts, but more concerning in other contexts. For example, if a sound is identified as a humming or whining type of sound, such as made by a transformer coil in a power supply, that sound may be normal in certain contexts, such as if it is detected by a sensor close to the coil (where the sound may be louder) but may be abnormal in other contexts, e.g., if such a sound loud enough to be detected by a sensor located in an area that is significantly remote to the power supply, such as at or near a computer monitor. As will be understood, this detection and analysis, in certain embodiments, are made automatically, continuously, and/or dynamically.

By applying this information (e.g., context), the machine learning model 710 of the recommendation engine 145 automatically classifies the type of steps needed in this context and records the context and steps that are used. In certain embodiments, given the complexity of the data dimension for making decisions on the recommended resolution activity 714 and other steps needed, it is appropriate to leverage one or more machine learning algorithms for performance and accuracy. For example, in the embodiment of FIG. 7, the recommendation engine 145 leverages an ensemble, decision tree-based bagging technique named Random Forest 712 for multinomial classification of actions. In addition, the machine learning model 710 uses historical training data 718 containing multi-dimension data points to train the machine learning model 710. Once the machine learning model 710 is fully trained, the conversation's state (intent and context) is passed to predict the steps needed as part of the recommended resolution activity. The Random Forest algorithm 712 uses a large group of complex decision trees and can provide classification predictions with a high degree of accuracy on any size of data. This engine algorithm will predict the recommended action or other recommended resolution activity 714 with the accuracy or likelihood percentage. The accuracy of the model can be improved by hyperparameter tuning.

Referring again to FIGS. 1B, 1C, and 7, after solutions are attempted (if possible) and recommended resolutions are converted to either natural language instructions or automatic control signals, as applicable (blocks 178-180), or after additional troubleshooting is attempted, if necessary (block 174), processing can either be done (if no more sounds need to be processed) or can continue with ongoing sound collection and processing (block 186).

As the above description demonstrates, by leveraging the advanced capabilities of machine learning techniques, the embodiments herein help to transform the paradigm of remote system diagnosis. This innovative approach captures sound waves, conducts thorough analysis, and delivers proactive diagnoses, marking a significant evolution in the field.

At least some of the above-described embodiments help to implement an advantageous Sound-Based Remote Diagnosis, providing a unique approach to remotely diagnose computer system issues by analyzing the sounds emitted during normal operation. This departure from conventional diagnostic methods offers a non-intrusive and efficient way to identify potential problems without the need for physical presence or complex software tools.

In addition, at least some of the above-described embodiments help to implement an advantageous Machine Learning-Powered Sound Pattern Analysis, which methodology involves the use of advanced machine learning techniques to analyze and categorize distinct sound patterns produced by various system components. This novel application of machine learning enables the correlation of specific sound patterns with known hardware or software issues, enhancing the accuracy and speed of remote diagnosis.

Further, at least some embodiment described above help to provide early and proactive resolution of problems, enabling proactive issue resolution by utilizing a system's recorded sounds, which can be embedded in telemetry data that is then transmitted to a central (and optionally remote) machine learning-driven engine. This engine consistently examines these sounds, comparing them with a database of known problems. This real-time correlation empowers accurate remote diagnostics and provides timely recommendations for addressing issues before they escalate.

As can be seen, at least some embodiments of the Acoustic-Driven Computer System Impact Analysis and Remediation arrangements discussed herein represent a transformative leap in computer system diagnostics and maintenance. By harnessing the power of sound analysis, at least some of the embodiments herein offer offers an efficient, remote, and user-friendly method for diagnosing and resolving computer issues.

The embodiments described herein have many applications, as will be appreciated. It also is expected that the embodiments herein can be combined with and/or adapted to work with arrangements described in the following commonly assigned patents, which are hereby incorporated by reference:
U.S. Pat. No. 6,304,865, entitled “Audio diagnostic system and method using frequency spectrum and neural network,” issued on Oct. 16, 2001;
U.S. Pat. No. 8,995,670, entitled “Systems and methods for local and remote recording, monitoring, control and/or analysis of sounds generated in information handling system environments,” issued on Mar. 31, 2015; and
U.S. Pat. No. 11,836,062, entitled “System and method of managing acoustics of information handling systems,” issued on Dec. 5, 2023.

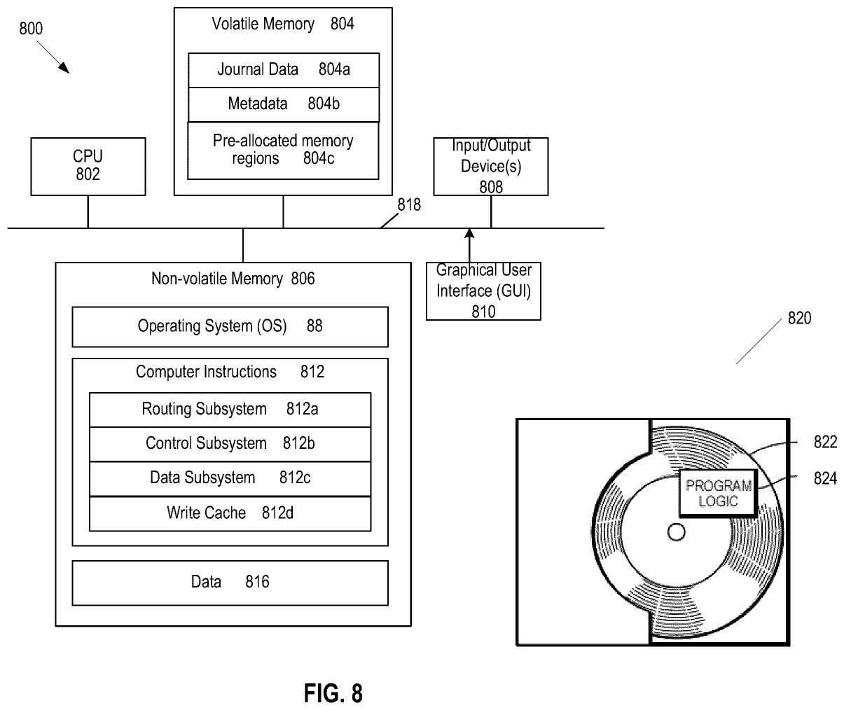

At least some of the embodiments herein can be implemented using one or more exemplary computer systems. For example, FIG. 8 is a block diagram of an exemplary computer system usable with at least some of the systems, methods, examples, and outputs of FIGS. 1A-7, in accordance with one embodiment. Reference is made briefly to FIG. 8, which shows a block diagram of a computer system 800 that is usable with at least some embodiments. The computer system 800 also can be used to implement all or part of any of the methods, systems, and/or devices described herein.

As shown in FIG. 8, computer system 800 may include processor/central processing unit (CPU) 802, volatile memory 804 (e.g., RAM), non-volatile memory 806 (e.g., one or more hard disk drives (HDDs), one or more solid state drives (SSDs) such as a flash drive, one or more hybrid magnetic and solid state drives, and/or one or more virtual storage volumes, such as a cloud storage, or a combination of physical storage volumes and virtual storage volumes), graphical user interface (GUI) 810 (e.g., a touchscreen, a display, and so forth) and input and/or output (I/O) device 808 (e.g., a mouse/keyboard 850, a camera 852, a microphone 854, speakers 856 and optionally other custom sensors 858, providing user input, such as biometric sensors, accelerometers, position sensors, etc.). A bus 818 interconnects the CPU 802, volatile memory 804, non-volatile memory 806, GUI 810, I/O devices 808, speakers 856, keyboard/mouse 850, camera 852 (e.g., webcam), microphone 854, and/or other custom sensors 858.

Non-volatile memory 806 stores, e.g., journal data 804a, metadata 804b, and pre-allocated memory regions 804c. The non-volatile memory, 806 can include, in some embodiments, an operating system 814, and computer instructions 812, and data 816. In certain embodiment, the non-volatile memory 806 is configured to be a memory storing instructions that are executed by a processor, such as processor/CPU 802. In certain embodiments, the computer instructions 812 are configured to provide several subsystems, including a routing subsystem 812A, a control subsystem 812b, a data subsystem 812c, and a write cache 812d. In certain embodiments, the computer instructions 812 are executed by the processor/CPU 802 out of volatile memory 804 to implement and/or perform at least a portion of the systems and processes shown in FIGS. 1-13. Program code also may be applied to data entered using an input device or GUI 810 or received from I/O device 808.

The systems, architectures, and processes of FIGS. 1A-8 are not limited to use with the hardware and software described and illustrated herein and may find applicability in any computing or processing environment and with any type of machine or set of machines that may be capable of running a computer program. The processes described herein may be implemented in hardware, software, or a combination of the two. The logic for carrying out the methods discussed herein may be embodied as part of the system described in FIG. 8. The processes and systems described herein are not limited to the specific embodiments described, nor are they specifically limited to the specific processing order shown. Rather, any of the blocks of the processes may be re-ordered, combined, or removed, performed in parallel or in serial, as necessary, to achieve the results set forth herein.

Processor/CPU 802 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs). In some embodiments, the “processor” may be embodied in one or more microprocessors with associated program memory. In some embodiments, the “processor” may be embodied in one or more discrete electronic circuits. The “processor” may be analog, digital, or mixed-signal. In some embodiments, the “processor” may be one or more physical processors or one or more “virtual” (e.g., remotely located or “cloud”) processors.

Various functions of circuit elements may also be implemented as processing blocks in a software program. Such software may be employed in, for example, one or more digital signal processors, microcontrollers, or general-purpose computers. Described embodiments may be implemented in hardware, a combination of hardware and software, software, or software in execution by one or more physical or virtual processors.

Some embodiments may be implemented in the form of methods and apparatuses for practicing those methods. Described embodiments may also be implemented in the form of program code, for example, stored in a storage medium, loaded into and/or executed by a machine, or transmitted over some transmission medium or carrier, such as over electrical wiring or cabling, through fiber optics, or via electromagnetic radiation. A non-transitory machine-readable medium may include but is not limited to tangible media, such as magnetic recording media including hard drives, floppy diskettes, and magnetic tape media, optical recording media including compact discs (CDs) and digital versatile discs (DVDs), solid state memory such as flash memory, hybrid magnetic and solid-state memory, non-volatile memory, volatile memory, and so forth, but does not include a transitory signal per se. When embodied in a non-transitory machine-readable medium and the program code is loaded into and executed by a machine, such as a computer, the machine becomes an apparatus for practicing the method.

When implemented on one or more processing devices, the program code segments combine with the processor to provide a unique device that operates analogously to specific logic circuits. Such processing devices may include, for example, a general-purpose microprocessor, a digital signal processor (DSP), a reduced instruction set computer (RISC), a complex instruction set computer (CISC), an application specific integrated circuit (ASIC), a field programmable gate array (FPGA), a programmable logic array (PLA), a microcontroller, an embedded controller, a multi-core processor, and/or others, including combinations of one or more of the above. Described embodiments may also be implemented in the form of a bitstream or other sequence of signal values electrically or optically transmitted through a medium, stored magnetic-field variations in a magnetic recording medium, etc., generated using a method and/or an apparatus as recited in the claims.

For example, when the program code is loaded into and executed by a machine, such as the computer of FIG. 8, the machine becomes an apparatus for practicing one or more of the described embodiments. When implemented on one or more general-purpose processors, the program code combines with such a processor to provide a unique apparatus that operates analogously to specific logic circuits. As such a general-purpose digital machine can be transformed into a special purpose digital machine. FIG. 8 shows Program Logic 824 embodied on a computer-readable medium 820 as shown, and wherein the Logic is encoded in computer-executable code thereby forms a Computer Program Product 822. The logic may be the same logic on memory loaded on processor. The program logic may also be embodied in software modules, as modules, or as hardware modules. A processor may be a virtual processor or a physical processor. Logic may be distributed across several processors or virtual processors to execute the logic.

In some embodiments, a storage medium may be a physical or logical device. In some embodiments, a storage medium may consist of physical or logical devices. In some embodiments, a storage medium may be mapped across multiple physical and/or logical devices. In some embodiments, storage medium may exist in a virtualized environment. In some embodiments, a processor may be a virtual or physical embodiment. In some embodiments, a logic may be executed across one or more physical or virtual processors.

For purposes of illustrating the present embodiments, the disclosed embodiments are described as embodied in a specific configuration and using special logical arrangements, but one skilled in the art will appreciate that the device is not limited to the specific configuration but rather only by the claims included with this specification. In addition, it is expected that during the life of a patent maturing from this application, many relevant technologies will be developed, and the scopes of the corresponding terms are intended to include all such new technologies a priori.

The terms “comprises,” “comprising”, “includes”, “including”, “having” and their conjugates at least mean “including but not limited to”. As used herein, the singular form “a,” “an” and “the” includes plural references unless the context clearly dictates otherwise. Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

Throughout the present disclosure, absent a clear indication to the contrary from the context, it should be understood individual elements as described may be singular or plural in number. Additionally, terms such as “input,” “output,” “message” and “signal” may refer to one or more currents, one or more voltages, and/or a data signal. Within the drawings, like or related elements have like or related alpha, numeric or alphanumeric designators. Further, while the disclosed embodiments have been discussed in the context of implementations using discrete components, including some components that include one or more integrated circuit chips), the functions of any component or circuit may alternatively be implemented using one or more appropriately programmed processors, depending upon the signal frequencies or data rates to be processed and/or the functions being accomplished.

Similarly, in addition, in the Figures of this application, in some instances, a plurality of system elements may be shown as illustrative of a particular system element, and a single system element or may be shown as illustrative of a plurality of particular system elements. It should be understood that showing a plurality of a particular element is not intended to imply that a system or method implemented in accordance with the disclosure herein must comprise more than one of that element, nor is it intended by illustrating a single element that the any disclosure herein is limited to embodiments having only a single one of that respective elements. In addition, the total number of elements shown for a particular system element is not intended to be limiting; those skilled in the art can recognize that the number of a particular system element can, in some instances, be selected to accommodate the particular user needs.

In describing and illustrating the embodiments herein, in the text and in the figures, specific terminology (e.g., language, phrases, product brands names, etc.) may be used for the sake of clarity. These names are provided by way of example only and are not limiting. The embodiments described herein are not limited to the specific terminology so selected, and each specific term at least includes all grammatical, literal, scientific, technical, and functional equivalents, as well as anything else that operates in a similar manner to accomplish a similar purpose. Furthermore, in the illustrations, Figures, and text, specific names may be given to specific features, elements, circuits, modules, tables, software modules, systems, etc. Such terminology used herein, however, is for the purpose of description and not limitation.

Although the embodiments included herein have been described and pictured in an advantageous form with a certain degree of particularity, it is understood that the present disclosure has been made only by way of example, and that numerous changes in the details of construction and combination and arrangement of parts may be made without departing from the spirit and scope of the described embodiments. Having described and illustrated at least some the principles of the technology with reference to specific implementations, it will be recognized that the technology and embodiments described herein can be implemented in many other, different, forms, and in many different environments. The technology and embodiments disclosed herein can be used in combination with other technologies. In addition, all publications and references cited herein are expressly incorporated herein by reference in their entirety. Individual elements of different embodiments described herein may be combined to form other embodiments not specifically set forth above. Various elements, which are described in the context of a single embodiment, may also be provided separately or in any suitable sub-combination.

What is claimed is:

1. A computer-implemented method, comprising:
receiving, at a first system in a first location, one or more detected sounds, the detected sounds being generated in in a second system at a second location;
performing real-time noise removal on the detected sounds to produce a set of noise removed sound information;
analyzing the set of noise removed sound information to determine at least one classification of at least a portion of the set of noise removed sound information;
correlating the at least one classification to a diagnosis of at least one potential issue in the first system;
generating automatically, based on the at least one potential issue, one or more actions to take to respond to the at least one potential issue; and
causing instructions, regarding the one or more actions to take to respond to the at least one potential issue, to be provided to one or more systems configured to perform the actions automatically and without human intervention.

2. The computer-implemented method of claim 1, further comprising converting the instructions into at least one of:
natural language instructions provided to a human operator;
control signals to enable a control system to automatically perform the one or more actions, wherein the control system is distinct from the first system and the second system; and
control signals configured to cause at least one of the first system and the second system to automatically perform the one or more actions.

3. The computer-implemented method of claim 1, wherein the real-time noise removal further comprises processing the detected sounds in a dual-signal transformation long short-term memory (DTLN) network.

4. The computer-implemented method of claim 1, wherein analyzing the set of noise removed sounds further comprises:
converting the set of noise removed sound information into a corresponding set of spectrograms, each spectrogram in the corresponding set of spectrograms depicting an image of a sound pattern in the set of noise removed sound information;
providing each spectrogram into a convolution neural network (CNN) to generate at least one feature map associated with each spectrogram, the feature map comprising an encoded representation of the spectrogram and configured to indicate at least one feature associated with the sound pattern;
cross referencing the feature map to a database of known issues associated with one or more corresponding sound patterns; and
determining at least one classification based on the feature map.

5. The computer-implemented method of claim 1, further comprising providing a machine learning model that is configured to provides information used for performing at least one of:
(a) determining the at least one classification of the at least a portion of the set of noise removed sound information;
(b) correlating the at least one classification to the diagnosis of at least one potential issue in the first system; and
(c) generating automatically, based on the at least one potential issue, one or more actions to take to respond to the at least one potential issue.

6. The computer-implemented method of claim 5 wherein analyzing the set of noise removed sounds further comprises performing audio data augmentation (ADA) on each spectrogram in the corresponding set of spectrograms before providing the spectrogram to the machine learning model, wherein the ADA is configured to improve a training data set used with the machine learning model.

7. The computer-implemented method of claim 1, wherein analyzing the set of noise removed sounds further comprises standardizing the set of noise removed sounds before converting the set of noise removed sounds into a corresponding set of spectrograms.

8. The computer-implemented method of claim 1, wherein the classification corresponds to textual information and wherein correlating the at least one classification to a diagnosis further comprises:
analyzing the textual information via context analysis of a machine learning model having a knowledge repository; and
determining a diagnosis based on an analysis of whether the textual information matches information stored in the knowledge repository.

9. The method of claim 1, wherein the first location is remote from the second location.

10. A system, comprising:
a processor; and
a non-volatile memory in operable communication with the processor and storing computer program code that when executed on the processor causes the processor to execute a process operable to perform operations of:
receiving, at a first system in a first location, one or more detected sounds, the detected sounds being generated in in a second system at a second location;
performing real-time noise removal on the detected sounds to produce a set of noise removed sound information;
analyzing the set of noise removed sound information to determine at least one classification of at least a portion of the set of noise removed sound information;
correlating the at least one classification to a diagnosis of at least one potential issue in the first system;
generating automatically, based on the at least one potential issue, one or more actions to take to respond to the at least one potential issue; and
causing instructions, regarding the one or more actions to take to respond to the at least one potential issue, to be provided to one or more systems configured to perform the actions automatically and without human intervention.

11. The system of claim 10, further comprising providing computer program code that when executed on the processor causes the processor to perform an action comprising converting the instructions into at least one of:
natural language instructions provided to a human operator;
control signals to enable a control system to automatically perform the one or more actions, wherein the control system is distinct from the first system and the second system; and
control signals configured to cause at least one of the first system and the second system to automatically perform the one or more actions.

12. The system of claim 10, wherein the real-time noise removal further comprises processing the detected sounds in a dual-signal transformation long short-term memory (DTLN) network.

13. The system of claim 10, further comprising providing computer program code that when executed on the processor causes the processor to perform actions comprising:
converting the set of noise removed sound information into a corresponding set of spectrograms, each spectrogram in the corresponding set of spectrograms depicting an image of a sound pattern in the set of noise removed sound information;
providing each spectrogram into a convolution neural network (CNN) to generate at least one feature map associated with each spectrogram, the feature map comprising an encoded representation of the spectrogram and configured to indicate at least one feature associated with the sound pattern;
cross referencing the feature map to a database of known issues associated with one or more corresponding sound patterns; and
determining at least one classification based on the feature map.

14. The system of claim 10, further comprising computer program code that when executed on the processor causes the processor to perform an action comprising providing a machine learning model that is configured to provides information used for performing at least one of:
(a) determining the at least one classification of the at least a portion of the set of noise removed sound information;
(b) correlating the at least one classification to the diagnosis of at least one potential issue in the first system; and
(c) generating automatically, based on the at least one potential issue, one or more actions to take to respond to the at least one potential issue.

15. The system of claim 14, further comprising providing computer program code that when executed on the processor causes the processor to perform an action comprising at least one of:
analyzing the set of noise removed sounds further comprises performing audio data augmentation (ADA) on each spectrogram in the corresponding set of spectrograms before providing the spectrogram to the machine learning model, wherein the ADA is configured to improve a training data set used with the machine learning model.

16. The system of claim 10, wherein the classification corresponds to textual information and further comprising providing computer program code that when executed on the processor causes the processor to perform actions comprising:
analyzing the textual information via context analysis of a machine learning model having a knowledge repository; and
determining a diagnosis based on an analysis of whether the textual information matches information stored in the knowledge repository.

17. A computer-implemented method, comprising:
receiving, at a first system in a first location, one or more detected sounds, the detected sounds being generated in in a second system at a second location;
performing real-time noise removal on the detected sounds to produce a set of noise removed sound information;
analyzing the set of noise removed sound information, using a machine learning model, to determine at least one classification of at least a portion of the set of noise removed sound information;
correlating the at least one classification to a diagnosis of at least one potential issue in the first system;
generating automatically, based on the at least one potential issue, one or more actions to take to respond to the at least one potential issue; and
causing instructions, regarding the one or more actions to take to respond to the at least one potential issue, to be provided to one or more systems configured to perform the actions automatically and without human intervention.

18. The computer-implemented method of claim 17, further comprising processing the detected sounds in a dual-signal transformation long short-term memory (DLTN) network.

19. The computer-implemented method of claim 17, further comprising:
converting the set of noise removed sound information into a corresponding set of spectrograms, each spectrogram in the corresponding set of spectrograms depicting an image of a sound pattern in the set of noise removed sound information;
providing each spectrogram into a convolution neural network (CNN) to generate at least one feature map associated with each spectrogram, the feature map comprising an encoded representation of the spectrogram and configured to indicate at least one feature associated with the sound pattern;
cross referencing the feature map to a database of known issues associated with one or more corresponding sound patterns; and
determining at least one classification based on the feature map.

20. The computer-implemented method of claim 19, further comprising performing audio data augmentation (ADA) on each spectrogram in the corresponding set of spectrograms before providing the spectrogram to the CNN, wherein the ADA is configured to improve a training data set used with the machine learning model.
